(19) United States
(12) Patent Application Publication
(10) Pub. No.: US 2026/0061513 A1
(43) Pub. Date: Mar. 5, 2026

(54) COMPOSITE MATERIAL, ITS PREPARATION AND USE

(71) Applicant: City University of Hong Kong, Kowloon (HK)

(72) Inventors: Yong Yang, Kowloon (HK); Yun Teng, Kowloon (HK); Wenqing ZHU, Kowloon (HK); Hao Gong, KKowloon (HK)

(21) Appl. No.: 19/274,917

(22) Filed: Jul. 21, 2025

Related U.S. Application Data
(60) Provisional application No. 63/687,832, filed on Aug. 28, 2024.

(51) Int. Cl. B23K 20/02; B23K 103/12; C22F 1/08

(52) U.S. Cl. CPC B23K 20/023; C22F 1/08; B23K 2103/12

(57) ABSTRACT

A composite material for bonding copper to copper includes a copper-based heterogeneous nanostructure, wherein the copper-based heterogeneous nanostructure includes a nanocrystalline copper and dispersions of copper oxide. Also addressed are the method of preparing and use of the composite material.

### TECHNICAL FIELD

The present invention relates to a composite material, for example, particularly, but not exclusively, a composite material such as a nanomembrane comprising a copper-based heterogeneous nanostructure for bonding copper to copper. The present invention also relates to the preparation and use of the composite material.

### BACKGROUND OF THE INVENTION

Metal-metal bonding plays a critical role in various fields, including aerospace engineering, automobile manufacturing, semiconductor industry, and micro- and nano-electronics. In the advanced packaging industry for next-generation nano-electronics, it is believed that there is a pressing need to develop efficient yet easy-to-implement metal-metal bonding techniques at small length scales, particularly for copper-copper (Cu) bonding in 2.5D or 3D packaging. This demand arises as devices continue to miniaturize, aiming to surpass the performance limits imposed by empirical laws like Moore's law.

Typical metal-metal bonding methods include soldering/brazing, fusion welding, and solid-state bonding. However, it is believed that each of these methods may have its drawbacks. For example, conventional filler metals like Sn—Pb solder alloys are not environmentally friendly and, more importantly, have sizes larger than a few micrometers, making them unsuitable for metal-metal bonding at submicron scales; fusion welding entails localized melting of base materials at high temperatures, requiring substantial energy inputs, making this method unsuitable for joining heat-sensitive substrates, such as those with low transition temperatures like ferroelectric materials, as well as flexible electronics or organic light-emitting devices; solid-state bonding, which typically involves significant plastic deformation in substrates at elevated temperatures, faces limitations when it comes to metal-metal bonding at the micro- or nano-scale due to stringent requirements on substrate materials (e.g., excellent plasticity, superior thermal stability and considerable interdiffusion ability).

The present invention thus seeks to eliminate or at least mitigate such shortcomings by providing a new or otherwise improved composite material for bonding metal to metal, particularly for bonding copper to copper.

### SUMMARY OF THE INVENTION

In a first aspect of the present invention, there is provided a composite material for bonding copper to copper comprising a copper-based heterogeneous nanostructure, wherein the copper-based heterogeneous nanostructure comprises a nanocrystalline copper and dispersions of copper oxide.

Optionally, the nanocrystalline copper is interspersed with the dispersions of copper oxide.

Optionally, the nanocrystalline copper and the dispersions of copper oxide have a volume ratio of about 8:2.

It is optional that the nanocrystalline copper and the dispersions of copper oxide have an atomic percentage ratio of about 90%:10%.

Optionally, the heterogeneous nanostructure has an average grain size of about 16 nm.

In an optional embodiment, the heterogeneous nanostructure includes at least one type of material defect of crystallography derived from lattice structures of the nanocrystalline copper and the dispersions of copper oxide.

Optionally, the at least one type of material defect of crystallography comprises twin boundary and stacking faults.

It is optional that the nanocrystalline copper has a lattice structure of hexagonal close packing symmetry.

Optionally, the dispersions of copper oxide are dispersions of copper (I) oxide having a mixed lattice structure of body-centered cubic symmetry and face-centered cubic symmetry.

In an optional embodiment, the composite material is in form of a membrane.

It is optional that the membrane has a thickness ranging from about 35 nm to about 50 nm.

Optionally, the membrane has a lateral size of ≥1 cm.

In an optional embodiment, the composite material has at least one of the following mechanical characteristics: a yield strength of about 850 MPa to about 1050 MPa; a ductility of about 37% to about 43%; an elastic modulus of about 32 GPa to about 38 GPa; and an elastic strain limit of about 2.4% to about 3.0%.

Optionally, the composite material is adapted to be disposed between a first and a second copper surfaces for bonding under a condition of a temperature of about 200° C. to about 300° C., a pressure of 10 MPa and in a vacuum of 2×10⁻² Pa, for about 3 min to about 300 min.

It is optional that at least one of the first and the second copper surfaces is a patterned copper surface.

Optionally, the composite material bonds the first and the second copper surfaces with an internal shear strength, wherein the internal shear strength is up to about 73 MPa at room temperature.

It is optional that the internal shear strength is about 35 times greater than that of a copper-copper bond without the composite material.

In a second aspect of the present invention, there is provided a method of preparing the composite material in accordance with the first aspect comprising the steps of: (a) depositing a layer of Cu onto a water-absorbing substrate by ion beam sputtering or electron beam evaporation; (b) immersing the deposited water absorbing substrate of (a) into water for absorption for a predetermined of time; (c) separating the composite material from the deposited water-absorbing substrate.

Optionally, the water-absorbing substrate in step (a) comprises a composite substrate in dehydrated form.

It is optional that the composite substrate in dehydrated form is prepared by the step of spin-coating a layer of hydrogel onto a base substrate, followed by dehydrating the spin-coated layer of hydrogel.

Optionally, the layer of hydrogel comprises poly(vinyl alcohol) (PVA).

It is optional that the base substrate comprises glass or polyimide (PI).

In an optional embodiment, the step of spin-coating of the layer of hydrogel comprises spin-coating a PVA solution onto a glass plate to form a PVA-glass composite substrate.

Optionally, the spin-coating is carried out at about 1000 to about 3000 rpm for about 30 to about 300 seconds.

It is optional that the PVA solution has a concentration of about 8 wt. % to about 11 wt. %.

Optionally, the PVA-glass composite substrate is dehydrated at about 60° C. to about 90° C. for about 1 to about 24 hours.

In an optional embodiment, the electron beam evaporation is carried out under a pressure of less than 6×10⁻⁴ Pa at a nominal deposition rate of about 1 Å/s.

In an optional embodiment, the ion beam sputtering is carried out under a stable deposition rate.

It is optional that the deposited water-absorbing substrate of (a) is immersed into water for about 120 seconds to about 600 seconds.

In a third aspect of the present invention, there is provided a method of fabricating a joined body comprising the step of: (a) disposing one or more layer of the composite material in accordance with the first aspect between a first copper surface and a second copper surface, to form a pre-joined body; (b) annealing the pre-joined body in step (a) for bonding the first and the second copper surfaces through the one or more layer of the composite material; wherein the first and the second copper surfaces in step (a) are non-planarized surfaces.

Optionally, the method further comprises the step of applying a pressure of about 10 N to about 100 N to the pre-joined body in step (a) to facilitate contact of the first copper surface, the composite material and the second copper surface.

It is optional that step (b) is carried out under a condition of a temperature of about 200° C. to about 300° C., a pressure of 10 MPa and in a vacuum of 2×10⁻² Pa, for about 3 min to about 300 min.

In an optional embodiment, at least one of the first and the second copper surfaces is a layer of copper deposited on a base substrate comprising Si wafer.

Optionally, the layer of copper partially covers the base substrate.

It is optional that the layer of copper fully covers the base substrate.

Optionally, each of the first and the second copper surfaces is a layer of copper deposited on a base substrate comprising Si wafer.

It is optional that the layer of copper is deposited on the based substrate by magnetron sputtering.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1A is a schematic diagram illustrating the deposition process of unpatterned Cu substrate;

FIG. 1B is a schematic diagram illustrating the deposition process of patterned Cu substrate;

FIG. 1C shows the optical image of the deposition mask;

FIG. 1D shows the optical image of the deposited patterned Cu substrate;

FIG. 2 shows the optical imager of direct Cu—Cu bonding sample without Cu NM;

FIG. 3 shows the bonding results of direct Cu—Cu bonding experiments without Cu nanomembranes (NMs);

FIG. 4 shows the optical image of Cu—Cu bonding samples with Cu NMs;

FIG. 5 shows the photograph of the 48 nm-thick Cu NMs peeled off from a PVA substrate and floating in water. The inset displays the Cu NM transferred onto a fingertip;

FIG. 6A shows the atomic force microscope (AFM) topographic image of the 35 nm-thick Cu nanomembrane (NM) on silicon. The insert is the line scan profile across the edge of the 35 nm-thick Cu NM;

FIG. 6B shows the root mean square roughness (Rq) of the 35 nm-thick Cu NM;

FIG. 6C shows the AFM topographic image of the 48 nm-thick Cu NM on silicon. The insert is the line scan profile across the edge of the 48 nm-thick Cu NM;

FIG. 6D shows the Rq of the 48 nm-thick Cu NM;

FIG. 7 shows the transmission electron microscopy (TEM) image illustrating the nanostructure of the Cu NM;

FIG. 8A shows the grain size distribution in Cu NM with an average grain size of 16 nm;

FIG. 8B shows the TEM image of a 48 nm-thick Cu NM;

FIG. 8C shows the selective area electron diffraction (SAED) pattern of the 48 nm-thick Cu NM;

FIG. 8D shows the stacking fault defects in the Cu NM, with a magnification scale of 10 nm;

FIG. 8E shows the stacking fault defects in the Cu NM, with a magnification scale of 2 nm;

FIG. 8F shows the twin boundary defects in the Cu NM, with a magnification scale of 10 nm;

FIG. 8G shows the twin boundary defects in the Cu NM, with a magnification scale of 2 nm;

FIG. 9 shows the high-angle annular dark-field scanning TEM (HAADF-STEM) image with corresponding elemental mapping of Cu, C, and O. Elemental mapping region is highlighted by the dashed rectangle;

FIG. 10A shows the narrow-scan XPS spectra of C 1s of the 48 nm-thick Cu NM as a function of etching time;

FIG. 10B shows the narrow-scan XPS spectra of Cu 2p of the 48 nm-thick Cu NM as a function of etching time;

FIG. 10C shows the narrow-scan XPS spectra of O 1s of the 48 nm-thick Cu NM as a function of etching time;

FIG. 10D shows the narrow-scan XPS spectra of C 1s of the 48 nm-thick Cu NM with an etching time of 0 s;

FIG. 10E shows the narrow-scan XPS spectra of Cu 2p of the 48 nm-thick Cu NM with an etching time of 0 s;

FIG. 10F shows the narrow-scan XPS spectra of O 1s of the 48 nm-thick Cu NM with an etching time of 0 s;

FIG. 10G shows the narrow-scan XPS spectra of C 1s of the 48 nm-thick Cu NM with an etching time of 400 s;

FIG. 10H shows the narrow-scan XPS spectra of Cu 2p of the 48 nm-thick Cu NM with an etching time of 400 s;

FIG. 10I shows the narrow-scan XPS spectra of O 1s of the 48 nm-thick Cu NM with an etching time of 400 s;

FIG. 11 shows the atomic percentage of Cu, C and O of the 48 nm-thick Cu NM with different etching time;

FIG. 12A shows the atomic force microscopy (AFM) scanning revealing the surface profile of the Cu NM;

FIG. 12B shows the electric current mapping of the Cu NM obtained through conductive AFM (C-AFM) under an applied voltage of 5 mV;

FIG. 13 shows the calculated height-height correlation function (HHCF) from FIG. 12B;

FIG. 14 shows the comparison of the sheet resistance of the Cu NM with that of nanotwinned (NT) Cu, nanocrystalline (NC) Cu, bulk Cu, CuO and Cu₂O;

FIG. 15 is a table summarizing the electrical resistivity of Cu NM with those of CuO, Cu₂O, NC and NT Cu, and bulk Cu;

FIG. 16A shows the experimental loading/unloading curves of a 48 nm-thick Cu NM obtained through AFM indentation with increasing load, alongside the finite element analysis (FEA) results;

FIG. 16B shows the AFM scanning images of the suspended Cu NM before indentation;

FIG. 16C shows the AFM scanning images of the suspended Cu NM after indentation;

FIG. 17 shows the comparison of the yield strength and ductility of the Cu NMs with other materials;

FIG. 18 shows the comparison of the elastic modulus of the Cu NM with other materials;

FIG. 19 shows the comparison of the elastic strain limit and ductility of Cu NM with those of bulk Cu, polycrystalline (PC) Cu wires, nanocrystalline (NC) Cu, nanotwinned (NT) Cu, Cu nanowires (NWs) and single crystalline (SC) Cu;

FIG. 20 shows the elastic modulus of pure Cu, Cu with 5.3% O and 9.1% O as determined from molecular dynamics (MD) simulations;

FIG. 21 shows the FDSC heating curves of the Cu NMs with heating rates ranging from 10000 K/s to 100 K/s;

FIG. 22A shows the stress-strain curves of pure Cu, Cu with 5.3% O and 9.1% 0;

FIG. 22B is shows the atomic structure of Cu with 9.1% O at the unloading stage showing stacking-fault defects-Green, red and blue spheres represent FCC, HCP and BCC atoms, respectively while gray color represents other types;

FIG. 23A shows the TEM image of the as-prepared 48 nm-thick as-prepared Cu NM;

FIG. 23B shows the TEM image of the 48 nm-thick as-prepared Cu NM after iso-thermal annealing for 30 s at 573 K;

FIG. 23C shows the TEM image of the 48 nm-thick as-prepared Cu NM after iso-thermal annealing for 30 s at 673 K;

FIG. 24 shows the activation energy of grain growth in the 48 nm-thick Cu NM determined by fitting the Kissinger equation to the experimental data;

FIG. 25A shows the Rq of Cu substrate deposited on Si wafer;

FIG. 25B shows the side views of 3.5 mm Cu substrate deposited on Si wafer by SEM and the energy Dispersive Spectroscopy (EDS) mapping of the left enlarged SEM image;

FIG. 26A shows the annular dark-field (ADF) TEM images of Cu substrate deposited on silicon;

FIG. 26B shows the grain size distribution in Cu substrate with an average grain size of 136 nm;

FIG. 27 shows the elastic modulus of Cu substrate obtained from nanoindentation tests and fitting by King's model;

FIG. 28 is a table summarizing the comparison of environmental friendliness and cost of the various Cu—Cu bonding techniques;

FIG. 29 shows the comparison of measured shear strengths between Cu—Cu bonding with and without Cu NMs;

FIG. 30 shows the SEM (left) and AFM (right) images of the fractured surface resulting from Cu—Cu bonding without Cu NMs at a bonding time of 300 minutes;

FIG. 31 shows the SEM (left) and AFM (right) images of the fractured surface resulting from Cu—Cu bonding with one layer of Cu NM at a bonding time of 300 minutes;

FIG. 32 shows the SEM (left) and AFM (right) images of the fractured surface resulting from Cu—Cu bonding with three layers of Cu NMs at a bonding time of 300 minutes;

FIG. 33 shows the SEM images of fractured surface of Cu—Cu bonding sample without Cu NM under different magnification scales. All SEM images were taken at a tilt angle of 45° with respect to normal incidence;

FIG. 34 shows the SEM images of fractured surface of Cu—Cu bonding sample with one-layer Cu NM under different magnification scales. All SEM images were taken at a tilt angle of 45° with respect to normal incidence;

FIG. 35 shows the SEM images of fractured surface on the one side of Cu—Cu bonding sample with three-layer Cu NMs; All SEM images were taken at a tilt angle of 45° with respect to normal incidence;

FIG. 36 shows the SEM images of fractured surface on the other side of Cu—Cu bonding sample with three-layer Cu NMs. All SEM images were taken at a tilt angle of 45° with respect to normal incidence;

FIG. 37A shows the optical images of the fracture surface of Cu—Cu NM bonding with three-layer Cu NMs. The black solid arrows indicate the shear direction;

FIG. 37B shows the magnified optical images of the fracture surface of Cu—Cu NM bonding with three-layer Cu NMs in FIG. 37A. The black solid arrows indicate the shear direction;

FIG. 38 shows the comparison of the NM bonding technique in accordance with an embodiment of the present invention with other Cu—Cu bonding techniques in terms of bonding strength and environmental friendless. All SEM images were taken at a tilt angle of 45° with respect to normal incidence;

FIG. 39 shows the annular dark-field (ADF) TEM image of the bonding interface of Cu—Cu bonding with two layers of Cu NMs at the bonding time of 300 min;

FIG. 40 shows the TEM images of the bonding interface of Cu—Cu direct bonding without Cu NM (top), and the magnified TEM images of the crack tip for Cu—Cu direct bonding of the top SEM image (bottom);

FIG. 41A shows the HAADF-STEM (top, left) and the ADF TEM (bottom, left) images of region I in FIG. 39, and the elemental line scans (right) along the dashed lines in the HAADF-STEM and ADF TEM images;

FIG. 41B shows the HAADF-STEM (top, left) and the ADF TEM (bottom, left) images of region II in FIG. 39, and the elemental line scans (right) along the dashed lines in the HAADF-STEM and ADF TEM images;

FIG. 42 shows the TEM images of the bonding interface of Cu—Cu NM bonding with two-layer Cu NMs (top), and the magnified TEM images of the blunt crack tip for Cu—Cu NM bonding (bottom);

FIG. 43A shows the schematic illustration of the grain growth in Cu—Cu NM bonding. The dashed lines indicate the grain growth front. The black points represent the Cu₂O nano-oxides;

FIG. 43B shows the schematic illustration of the tortuous fracture process resulting from Cu—Cu NM bonding;

FIG. 44 shows the ADF TEM image of the Cu nanocrystal that extended from the Cu substrate into Cu NMs (highlighted by the dashed cycle) (left), and the ADF TEM image depicting the current grain boundary of the Cu nanocrystal (right);

FIG. 45 shows the IFFT-filtered HRTEM image of the region at the grain growth front, indicated by the black dashed rectangle in FIG. 44, right;

FIG. 46A shows the contour plot illustrating the distribution of von Mises strain ε_{Mises} in FIG. 45;

FIG. 46B shows the distribution analysis of von Mises strain ε_{Mises};

FIG. 47A shows the contour plot of the normal strain εₓₓ in FIG. 45;

FIG. 47B shows the distribution of the normal strain εₓₓ in FIG. 45;

FIG. 47C shows the contour plot of the normal strain ε_{xy} in FIG. 45;

FIG. 47D shows the distribution of the normal strain ε_{xy} in FIG. 45;

FIG. 47E shows the contour plot of the normal strain ε_{yy} in FIG. 45;

FIG. 47F shows the distribution of the normal strain ε_{yy} in FIG. 45;

FIG. 48A shows the atomistic models before and after bonding are depicted, showcasing two different tilt GBs (Σ5[001](210) and Σ41[001](910)) for the bi-crystal models;

FIG. 48B shows the energy difference per unit surface area after the occurrence of atomic bonding. Scatter points represent models with randomly oriented oxide interlayers;

FIG. 49 shows the snapshots of the bi-crystal Cu model with Σ41[001](910) GB under simple shear, without an interlayer of cuprous oxide—Green, red and blue spheres represent FCC, HCP and BCC atoms, respectively, while gray color represents other types—the arrows indicate the grain growth direction;

FIG. 50A shows the snapshots of the bi-crystal copper model with Σ5[001](210) GB subject to simple shear, without an interlayer of cuprous oxide;

FIG. 50B shows the grain growth distance versus time for Σ5[001](210) and Σ41[001](910) bi-crystal models;

FIG. 51 shows the snapshots of the bi-crystal Cu model with Σ41[001](910) GB under simple shear, with an interlayer of cuprous oxide. Green, red and blue spheres represent FCC, HCP and BCC atoms, respectively, while gray color represents other types. The arrows indicate the grain growth direction;

FIG. 52A shows the snapshots of fracture processes in bi-crystal copper with Σ5[001](210) GB under uniaxial tensile strains of 17.5%, 20% and 22.5%. Green, red and blue spheres represent FCC, HCP and BCC atoms, respectively while gray color represents other types;

FIG. 52B shows the snapshots of fracture processes in bi-crystal copper with Σ41[001](910) GB under uniaxial tensile strains of 17.5%, 20% and 22.5%. Green, red and blue spheres represent FCC, HCP and BCC atoms, respectively while gray color represents other types;

FIG. 53A shows the snapshots of fracture processes in bi-crystal copper with Σ5[001](210) GB, with an interlayer of cuprous oxide under uniaxial tensile strains of 17.5%, 20% and 22.5%. Green, red and blue spheres represent FCC, HCP and BCC atoms, respectively while gray color represents other types; and

FIG. 53B shows the snapshots of fracture processes in bi-crystal copper with Σ41[001](910) GB, with an interlayer of cuprous oxide under uniaxial tensile strains of 17.5%, 20% and 22.5%. Green, red and blue spheres represent FCC, HCP and BCC atoms, respectively while gray color represents other types.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

It is believed that nanomaterials may be utilized as an alternative for metal-metal bonding since nanomaterials may generally have lower melting temperatures and higher percentages of surface atoms as compared with conventional materials. However, it is believed that metal-metal involving nanomaterials may be hindered by their strict requirements of bonding size, crystal orientations (e.g., identical crystal orientations), complex and costly thermo-chemical processes such as formic acid pretreatment for deoxidation (removal of surface oxides).

Without wishing to be bound by theory, the inventors have through their own researches, trials and experiments devised a composite material for copper-copper bonding. Unexpectedly, it is devised that even the copper surfaces include surface oxides and/or random crystalline orientation, the heterogeneous nanostructure of the composite material may promote grain growth across the bonding interface between randomly oriented copper surfaces, leading to copper-copper bonding with significantly high bonding and/or shear strength under a low temperature and pressure. As used herein, the term “low temperature and pressure” for describe conditions for the copper-copper bonding are about 300° C. (e.g., 298° C. . . . 298.5° C. . . . 298.8° C. . . . 299° C. . . . 300° C. . . . 300.1° C. . . . 302° C. and the like) and about 1 MPa (0.8 MPa . . . 0.82 MPa . . . 0.85 MPa . . . 0.89 MPa . . . 0.9 MPa . . . 0.94 MPa . . . 0.98 MPa . . . 1 MPa . . . 1.03 MPa . . . 1.1 MPa . . . 1.15 MPa . . . 1.2 MPa and the like). As demonstrated in the later part of the present disclosure, the shear strength for copper-copper bonding with the composite material may be 35-fold greater than that without the composite material. It is also demonstrated that the preparation and the bonding methods of the present disclosure do not involve any potentially harmful chemicals. Accordingly, it is believed that the composite material as described herein may enable copper-copper bonding with environmental friendliness, cost-effectiveness, and remarkable efficiency.

In the first aspect of the present invention, there is provided a composite material for bonding copper to copper. The composite material may comprise a copper-based heterogeneous nanostructure, wherein the copper-based heterogeneous nanostructure may comprise a nanocrystalline copper and dispersions of copper oxide. In particular, the nanocrystalline copper may be interspersed with dispersions of the copper oxide. In some embodiments, the nanocrystalline copper and the dispersions of copper oxide may have a volume ratio of about 8:2 (e.g., 7.8:2, 7.8:2.02, 7.85:2, 8:2.01, 7.9:2.02, 7.95:2, 7.99:2.05 and the like). In other words, the heterogeneous nanostructure may have about 80% volume fraction of nanocrystalline copper and about 20% volume fraction of dispersions of copper oxide. In some embodiments, the nanocrystalline copper and the dispersions of copper oxide may have an atomic percentage ratio of about 90%:10%, such as 88%:12%, 88.5%:11.5%, 89%:11%, 89.2%:10.8%, 90%:10%, 90.1%:9.9%, 90.4%:9.6%, 91%:9%, 91.3%:8.7% and the like.

In some embodiments, the copper-based heterogeneous nanostructure may have an average grain size of about 15 nm to about 16 nm, such as 14.6 nm . . . 14.8 nm . . . 15 nm . . . 15.2 nm . . . 15.6 nm . . . 16 nm . . . 16.4 nm . . . 16.8 nm and the like. The copper-based heterogeneous nanostructure may include at least one type of material defect of crystallography derived from lattice structures of the nanocrystalline copper and the dispersions of copper oxide. In particular, the at least one type of material defect of crystallography may comprise twin boundary and stacking faults. Without wishing to be bound by theory, it is believed that the presence of the material defect(s) as described herein may contribute to the unexpectedly low elastic modulus of the composite material. In some embodiments, the nanocrystalline copper of the copper-based heterogeneous nanostructure may have a lattice structure of hexagonal close packing (hcp) symmetry; whereas the dispersions of copper oxide may be dispersions of copper (I) oxide having a mixed lattice structure of body-centered cubic (bcc) symmetry and face-centered cubic (fcc) symmetry.

In some embodiments, the composite material may be in form of a membrane such as a nanomembrane. The membrane may have a thickness ranging from about 35 nm to about 50 nm, such as 34.5 nm . . . 34.8 nm . . . 35 nm . . . 35.2 nm . . . 35.8 nm . . . 40 nm . . . 42 nm . . . 45.5 nm . . . 48 nm . . . 49.1 nm . . . 49.4 nm . . . 50 nm . . . 50.2 nm and the like. In some embodiments, the membrane may have a lateral size of ≥1 cm.

As mentioned above, the presence of the material defect(s) as described herein may contribute to the unexpectedly low elastic modulus of the composite material. In some embodiments, the composite material may have an elastic modulus of about 32 GPa to about 38 GPa such as 31.8 GPa . . . 32 GPa . . . 32.2 GPa . . . 35 GPa . . . 35.1 GPa . . . 38 GPa . . . 38.3 GPa and the like. In some additional embodiments, the composite material may have a yield strength of about 850 MPa to about 1050 MPa (such as 845 MPa . . . 848 MPa . . . 850 MPa . . . 855 MPa . . . 860 MPa . . . 1000 MPa . . . 1020 MPa . . . 1050 MPa . . . 1058 MPa and the like); a ductility of about 37% to about 43% (such as 36.5% . . . 36.8% . . . 37% . . . 37.2% . . . 37.5% . . . 38% . . . 39% . . . 42.1% . . . 42.6% . . . 43% . . . 43.3% and the like), and/or an elastic strain limit of about 2.4% to about 3.0% (such as 2.35% . . . 2.38% . . . 2.4% . . . 2.42% . . . 2.45% . . . 2.8% . . . 2.83% . . . 2.91% . . . 2.95% . . . 2.98% . . . 3.0% . . . 3.01% . . . 3.05% . . . 3.1% and the like).

In some embodiments, the composite material may be adapted to be disposed between a first and a second copper surfaces for bonding under a condition of, for instance, a temperature of about 200° C. to about 300° C., a pressure of 10 MPa and in a vacuum of 2×10⁻² Pa, for about 3 min to about 300 min. Without wishing to be bound by theory, each of the first and the second copper surfaces may be an unpatterned or a patterned copper surface. For example, in an embodiment, at least one of the first and the second copper surfaces may be a patterned surface. In an embodiment, both the first and the second copper surfaces may be patterned surfaces. In an embodiment, both the first and the second copper surfaces may be unpatterned surfaces.

In some embodiments, the composite material may bond to the first and the second copper surfaces with an internal shear strength, wherein the internal shear strength is up to about 73 MPa at room temperature. In some particular embodiments, the internal shear strength may be about 35 times (e.g. 33.8 times, 34 times, 34.5 times, 34.8 time, 35 times, 35.4 times and the like) greater than that of a copper-copper bond without the composite material.

Without wishing to be bound by theory, it is believed that the presence of the dispersions of copper oxide (i.e., nano-copper oxide dispersion) may impart an unexpectedly low elastic modulus of the composite material. This unexpected softness may lead to a significant elastic mismatch at the bonding interface when the composite material bonds to a Cu surface/substrate, generating substantial shear stress within it. In addition, when measured in iso-thermal annealing experiments, it is devised that the composite material may have fast atom diffusion kinetics, and when coupled with local shear stressing due to elastic mismatch, it may facilitate grain growth across the composite material. Furthermore, it is believed that the dispersions of copper oxide may exhibit strong bonding with Cu as a result of a high thermodynamic driving force. It is also devised that the oxide-Cu interface may have a higher toughness than Cu, preventing crack initiation at the bonded interface. Accordingly, without wishing to be bound by theory, it is believed that the combination of substantial grain growth in the Cu-rich region of the composite material and a tough interface in the nano-oxide-rich regions of the composite material may result in an ultra-tough and efficient copper-copper bonding via the composite material as described herein, regardless of Cu orientation of the Cu surface/substrate.

The method of preparing the aforementioned composite material will now be described. The method may be commenced with step (a) depositing a layer of Cu onto a water-absorbing substrate by ion beam sputtering or electron beam evaporation.

In some embodiments, the water-absorbing substrate may comprise a composite substrate in dehydrated form. As used herein, the phrases “dehydrated” or “dehydrated form” describe the material with about 85 wt. % to about 92 wt. % of its water/water content removed during the dehydration process.

Said composite substrate in dehydrated form may be prepared by the step of spin-coating a layer of hydrogel (e.g., poly(vinyl alcohol) (PVA)) onto a base substrate (e.g., glass or polyimide (PI)), followed by dehydrating the spin-coated layer of hydrogel. In a particular embodiment where the composite substrate comprises PVA and glass, such a composite substrate may be prepared by spin-coating a PVA solution (with a concentration of e.g., about 8 wt. % to about 11 wt. %, particularly of 8 wt. %) onto a glass plate to form a PVA-glass composite substrate at about 1000 to about 3000 rpm (such as about 1500 rpm) for about 30 to about 300 seconds, particularly about 60 seconds to about 120 seconds. After that the PVA-glass composite substrate may be dehydrated in, for example, an oven, at about 60° C. to about 90° C. (e.g. about 80° C.) for about 1 to about 24 hours.

The deposition of the layer of Cu onto the water-absorbing substrate such as the PVA-glass composite as described herein may be performed by ion beam sputtering or electron beam evaporation. In an embodiment where the ion beam sputtering is carried out for the deposition of the layer of Cu, it may be carried out under a condition of less than 6×10⁻⁴ Pa. In particular, the deposition rate for the ion bean sputtering may be controlled within about 10% fluctuation. In other words, the ion beam sputtering may be carried out under conditions of a stable deposition rate. In an embodiment where the electron beam evaporation is carried out for the deposition of the layer of Cu, it may be carried out under a pressure of less than 6×10⁻⁴ Pa at a nominal deposition rate of about 1 Å/s.

In step (b), the deposited water-absorbing substrate in step (a) such as the PVA-glass composite as described herein may be immersed into water such as deionized water for absorption for a predetermined period of time, such as for about 120 seconds to about 600 seconds. Without wishing to be bound by theory, it is believed that after step (b), the water-absorbing substrate to swell and buckle, thereby allowing subsequent separation/detachment of the composite material from the water-absorbing substrate in step (c).

As mentioned, it is believed that the composite material as described herein is particularly suitable for bonding copper to copper. In other words, it is believed that the composite material as described herein may be particularly suitable to fabricate joined bodies including one or more copper surfaces. Further pertained to the present invention is a method of fabricating a joined body. The method may comprise the steps of: (a) disposing one or more layer of the composite material as described herein between a first copper surface and a second copper surface, to form a pre-joined body; (b) annealing the pre-joined body in step (a) for bonding the first and the second copper surfaces through the one or more layer of the composite material. Advantageously, the method as described herein does not require any surface treatment such as plasma and chemical mechanical planarization (CMP) of the copper surfaces prior to bonding them. In other words, the first and the second copper surfaces in step (a) are non-planarized surfaces. As demonstrated in the later part of the present disclosure, even the method as described herein does not involve any planarization surface treatment, the fabricated joined body may have a greater shear strength as compared with the reported methods which involve surface treatment prior to bonding the copper surfaces.

Without wishing to be bound by theory, it is believed that the shear strength may be positively proportional to the number of layers of the composite material disposed between the first copper surface and a second copper surface for bonding. The number of layers of the composite material may be from 1 to 10, particularly 3 layers.

After disposing the one or more layer of the composite material as described herein between a first copper surface and a second copper surface, the method may further comprise the step of applying a pressure of about 10 N to about 100 N to the pre-joined body in step (a) to facilitate contact of the first copper surface, the composite material and the second copper surface. In an embodiment, the pressure may be applied to the pre-joined body throughout the whole fabrication process.

The pre-joined body may be annealed for under bonding the first and the second copper surfaces through the one or more layer of the composite material under a condition of a temperature of about 200° C. to about 300° C. (e.g., 198° C. to 300° C., 198° C. to 305° C., 200° C. to 305° C., 200° C. to 302° C., 199° C. to 300° C., 199° C. to 303° C., 201° C. to 300° C., 202° C. to 302° C. and the like) a pressure of 10 MPa and in a vacuum of 2×10⁻² Pa, for about 3 min to about 300 min (e.g., 2.8 min to 300 min, 2.8 min to 305 min, 3 min to 305 min, 2.9 min to 300 min, 2.9 min to 302 min, 3 min to 302 min and the like).

In some embodiments, at least one of the first and the second copper surfaces is a layer of copper deposited on a based substrate comprising Si wafer. For example, in an embodiment, the layer of copper may be deposited on a Si wafer including a Ti adhesion layer. In particular, the layer of copper may be deposited, by way of magnetron sputtering, onto the Ti adhesion layer that is deposited on the Si wafer. In some particular embodiments, the layer of copper may partially cover the based substrate. For example, a mask may be applied for the deposition of the layer of copper onto the base substrate such as the Si wafer including the Ti adhesion layer as described herein, thereby forming a layer of patterned copper onto the Ti adhesion layer of the Si wafer. In some other particular embodiments, the layer of copper may fully cover the base substrate. In these embodiments, the layer of copper may be prepared in a similar manner as the partially covered one except without using the mask during the deposition as described herein.

In some optional or additional embodiments, where there are further copper surfaces (e.g., a third copper surface, a fourth copper surface and the like) for bonding, it is appreciated that the method may be implemented by further disposing the one or more layer of composite material as described herein between the (additional) copper surfaces to form the pre-joined body, followed by the annealing step (b).

Hereinafter, the present invention is described more specifically by way of examples, but the present invention is not limited thereto.

### EXAMPLES

### Structure and Electronic Properties Characterization of Cu NMs

Various techniques have been employed to characterize the structure, chemical bonding and electronic properties of Cu NMs. The Cu NMs were transferred onto TEM grids, Si wafers, or glass slices for analysis. The thickness and surface profile of the Cu NMs on Si wafers were examined using AFM (Oxford Instruments, MFP-3D Infinity). Conventional field emission TEM (JEOL, JEM-2100) operating at an acceleration voltage of 200 kV was used to acquire TEM images and SAED patterns of the Cu NMs on TEM grids.

HAADF-STEM, annular bright filed (ABF), DF imaging and elemental mapping were performed using a Cs-corrected thermal field emission TEM (JEM, ARM200F) at 300 kV. High resolution XPS was employed to study the chemical bonding in the Cu NM. The sheet resistance (Rₛ) of the Cu NMs on glass slices was measured using the square four-point probe method (KEITHLEY instrument, 2450 SourceMeter). The electrical resistivity (r) was calculated through the equation Rₛ=C·ρ/t, where t is the thickness of the Cu NM and C is the correction factor. Additionally, C-AFM experiments were conducted on the Cu NMs transferred onto glass slices using conductive diamond probes (Adama Innovations, NC-LC) under an applied voltage of 5 mV.

### Thermal Property Characterization of Cu NMs

To assess the thermal properties of the Cu NMs, F-DSC experiments using the Mettler Flash-DSC 2+ and isothermal annealing experiments using Linkam TS1400XY heating stage were conducted. The F-DSC experiments were performed with the temperature ranging from −70° C. to 1000° C. and the heating rate varying from 100 K/s to 10000 K/s. Additionally, isothermal annealing experiments of these Cu NMs were performed on TEM grids under an Argon atmosphere annealing at 573 K or 673 K for a duration of 30 seconds. The grain growth in the annealed Cu NMs was observed using conventional field emission TEM.

### Mechanical Characterization of Cu NMs and Substrates

To assess the mechanical properties of Cu NMs, AFM indentation following the widely used circular drum indentation method were employed. The freestanding Cu NMs were transferred onto patterned Si wafers with a series of circular holes (diameter of 3 μm). AFM indentation tests were then conducted on the suspended Cu NMs with diamond probes (Adama Innovations, NC-LC). the elastic modulus, yielding strength, and ductility of the Cu NMs were derived by fitting the experimental data to finite element analysis (FEA) using the commercial software ANSYS (ANSYS Inc., USA).

An axisymmetric finite element model was constructed for the AFM indentation tests based on the experimental conditions, including the hole radius, tip radius, NM thickness and profile. For simplicity, it is assumed that a Poisson's ratio of 0.35 based on the property of bulk Cu. By utilizing elastic and elastoplastic constitutive equations, the elastic modulus and yield strength of the Cu NMs were obtained by fitting the experimental force-displacement curves. The maximum von Mises strain before strain softening was determined as the ductility of the Cu NMs.

The elastic modulus of the Cu substrate was determined through nanoindentation using a Berkovich tip on the Bruker TI950 nanoindentation system. We applied partial load-unload functions with 20 cycles over a period of 60 seconds, with a maximum load of 4 mN. To ensure data reliability, we repeated the indentation tests three times on different samples. The elastic modulus of the Cu substrate was determined by fitting the measured reduced modulus as a function to indentation depth to the King's model.

### Cu—Cu Bonding Experiments and Shear Tests

All bonding experiments were conducted using the bonding machine (ETOOL, ET-1212-300) without any surface treatment, applying a minimum force of 100 N to ensure contact between the two Cu surfaces to be bonded.

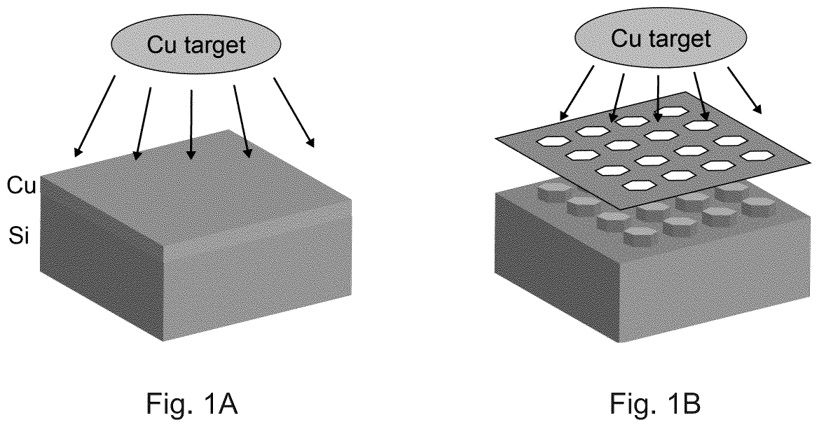

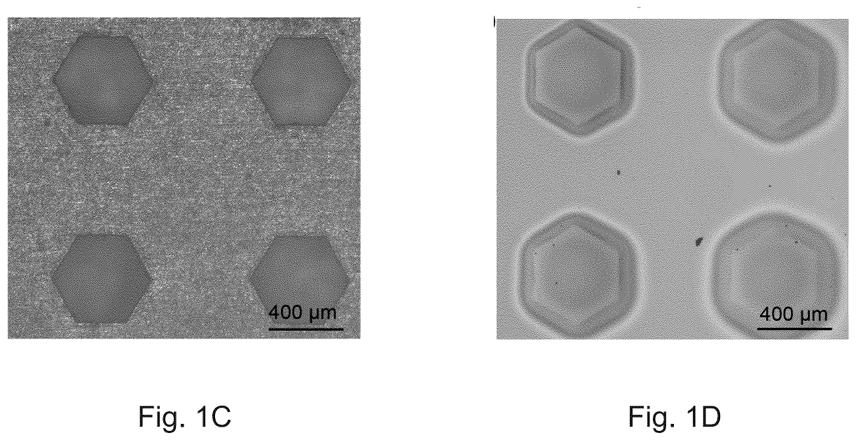

The Cu substrates were fabricated by depositing Cu onto Si wafers using magnetron sputtering (Sky Technology Development LTD, JGP560) (FIGS. 1A and 1B). During the deposition process, the processing chamber's base pressure was reduced to 6×10⁻⁴ Pa and then refilled it with 30 sccm Ar gas flow to maintain the working pressure at 1.3 Pa. A 50 nm-thick Ti adhesion layer was firstly deposited on Si wafers, followed by sequential sputtering of a 3.5 μm-thick Cu substrate with a size of 8×8 mm², which served as the bottom wafer for Cu—Cu bonding (FIG. 1A). Additionally, a mask was utilized to produce patterned Cu substrates, which were deposited on Si wafers with a size of 3×3 mm² (FIGS. 1B to 1D).

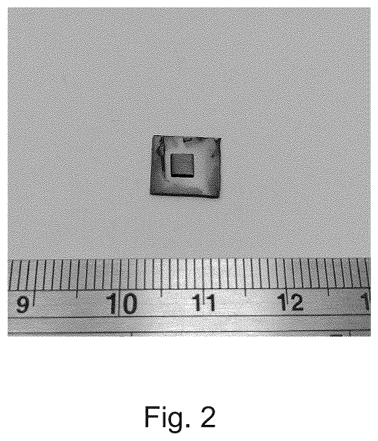

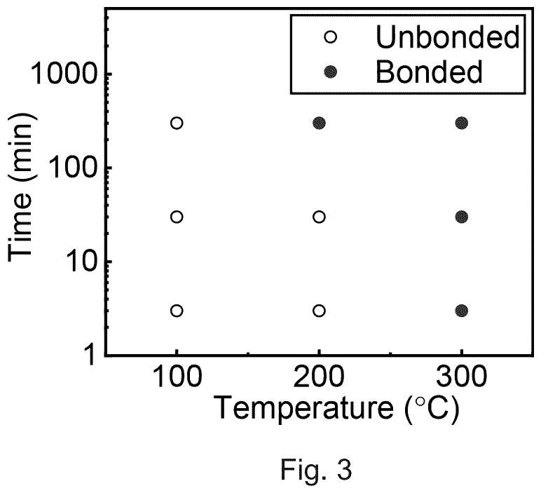

For Cu—Cu direct bonding (FIG. 2), the optimal bonding parameters were determined by performing bonding experiments at various bonding temperatures (100° C., 200° C. and 300° C.) and time periods (3 min, 30 min and 300 min), as illustrated in FIG. 3.

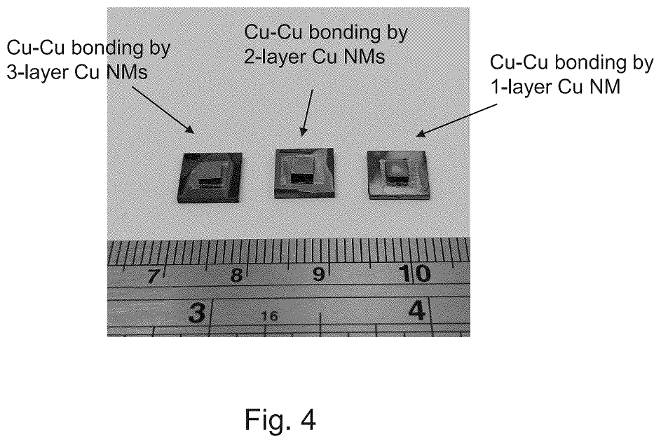

In the case of Cu NM enabled Cu—Cu bonding, a selected number of Cu NMs were transferred onto the surface of Cu substrates, ensuring that the Cu NMs were sandwiched between the Cu substrates to be bonded. Cu NM enabled Cu—Cu bonding (FIG. 4) was carried out at 300° C. with the annealing times of 3, 30, or 300 minutes.

Following the reported approach, shear tests were performed on the bonded Cu—Cu surfaces using the Nordson Dage 4000 Bond Tester. The tests were conducted both with and without Cu NMs. The shear height and rate were maintained at 50 μm and 100 μm/s, respectively. Shear stress (τ) was calculated using the formula τ=F/A, where F represents the shear force, and A is the nominal bonding area, which is equal to the area of the Cu substrate deposited on the Si wafer.

### Characterization of Bonded Interface

The bonded Cu—Cu interface was examined using conventional field emission TEM and Cs-corrected thermal field emission TEM. To prepare the TEM samples of the bonded interface, the FEI SEM/focused-ion beam (SEM/FIB) system was utilized. Initially, a 2 μm-thick Pt protection layer was deposited on the bonded interface region. Subsequently, a rectangular lamina measuring 10 μm×7 μm×1.4 μm from this region was created and transferred it on a Mo grid. The lamina's thickness was reduced to less than 100 nm from both sides using the gallium ion beam at a tilt angle of +1.2° and an accelerating voltage of 30 kV. We then polished the lamina sequentially using an ion beam of 48 pA at 5 kV, and of 27 pA at 2 kV.

### Molecular Dynamics (MD) Simulations

MD simulations of copper (Cu) and cuprous oxide (Cu₂O) were performed using the third-generation charge-optimized many body potential (COMB3), implemented in LAMMPS. Bi-crystal Cu models with different GB misorientation tilt angles (Σ5[001](210) and Σ41[001](910)), as well as Cu—Cu₂O—Cu models were generated using Atomsk. The Cu models had dimensions of 7.23×7.23×14.46 nm³, while the Cu—Cu₂O—Cu models had dimensions of 7.23×7.23×18.075 nm³. The models were annealed at 573 K for 100 ps, followed by cooling to 300 K in 1 ps and equilibration for 20 ps under the NVT ensemble. A timestep of 0.1 fs was used, and periodic boundary conditions were applied in all three directions. Electronegativity equilibration was performed every 10 timesteps during the simulations. To calculate the thermodynamic driving forces for bonding, the corresponding unbonded models with free surfaces were simulated using the same procedure. The energy differences per unit surface area between the two models, ΔE, were evaluated at 573 K.

Uniaxial tension and simple shear simulations were conducted on the annealed bonded models at a nominal strain rate of 5×10⁹ s⁻¹, still under the NVT ensemble. To investigate the effect of oxide content on the mechanical properties, uniaxial tension was performed on Cu₂O particle-embedded copper models with varying particle radius. These models had dimensions of 7.23×7.23× 7.23 nm³.

### Example 1

### Synthesis of Cu NMs

Cu NMs with thicknesses ranging from 35 nm to 48 nm were fabricated using the PSBEE method. Firstly, a layer of polyvinyl alcohol (PVA) was spin-coated on the surface of a glass plate to obtain a hydrogel thin film and dehydrated it in a drying oven at 80° C. for 1 h. Then, Cu was deposited onto the hydrogel thin film using electron beam evaporation (Junsun Tech LTD, EBS-500F) at a high vacuum (with pressure of 6×10⁻⁴ Pa). The Cu-hydrogel-glass system was immersed in deionized (DI) water. After a few minutes, the freestanding Cu NMs continuously delaminated from the hydrogel substrate.

### Example 2

### Structural Characterization of the Cu NMs

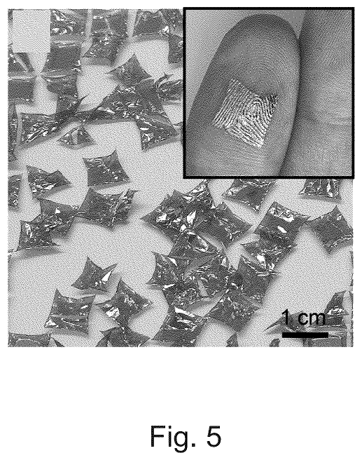

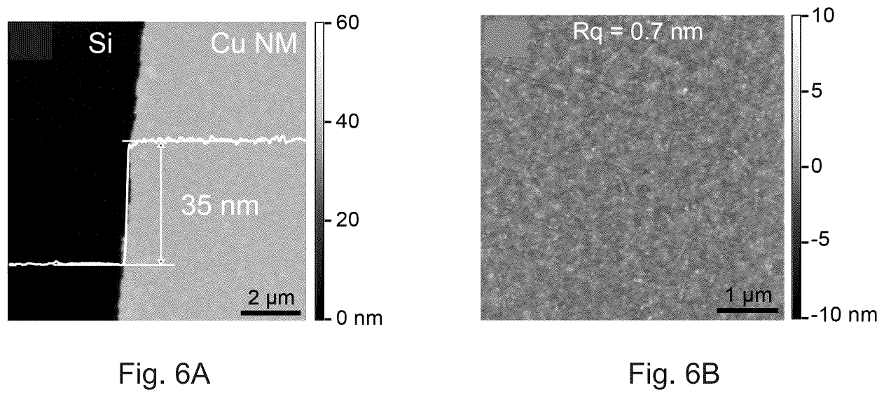

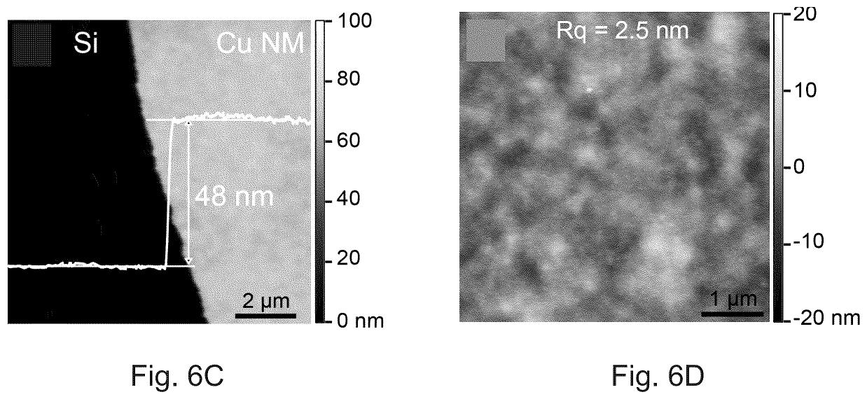

Following the PSBEE method, large-area, freestanding ultrathin Cu NMs were successfully fabricated (FIG. 5). The thickness of these NMs ranged from 35 nm to 48 nm (FIGS. 6A to 6D), and their lateral size could extend to approximately 1 cm or even larger. Remarkably, the inset in FIG. 5 illustrates the exceptional conformability of these ultrathin Cu NMs, as they could make conformable contact with human fingers, revealing the fine textures of fingerprints.

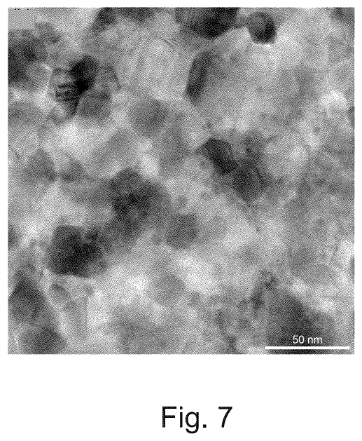

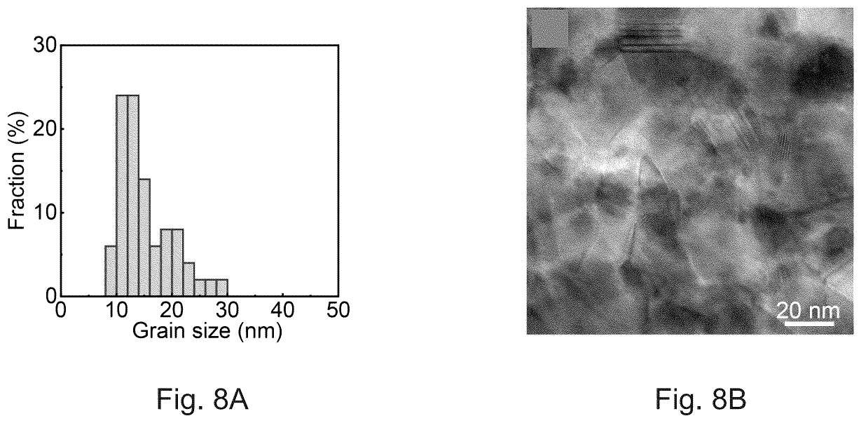

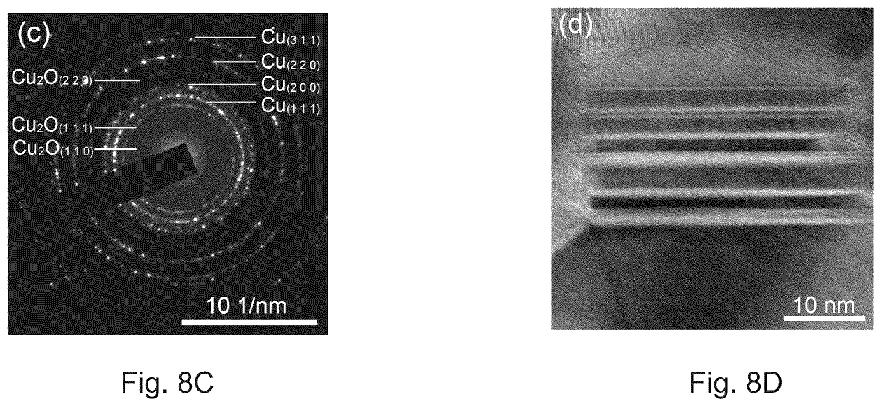

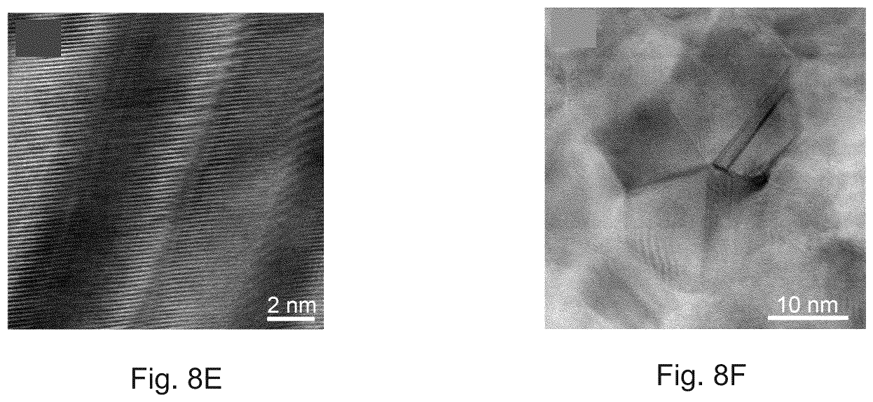

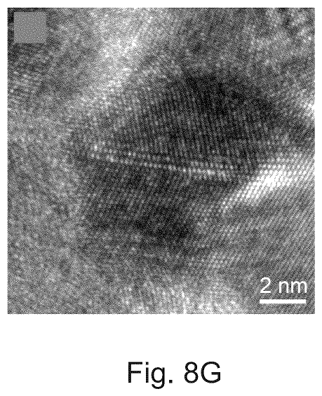

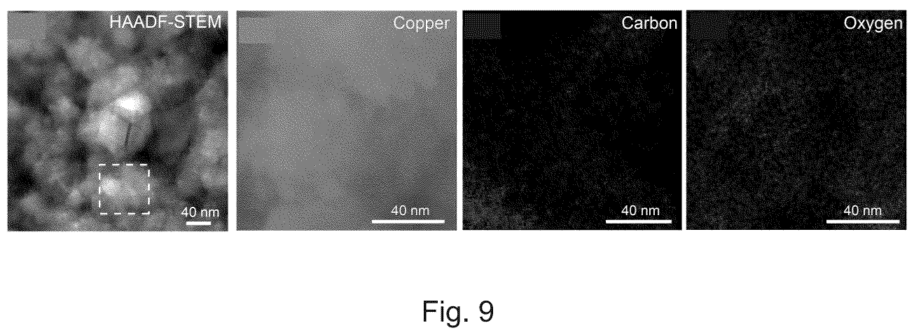

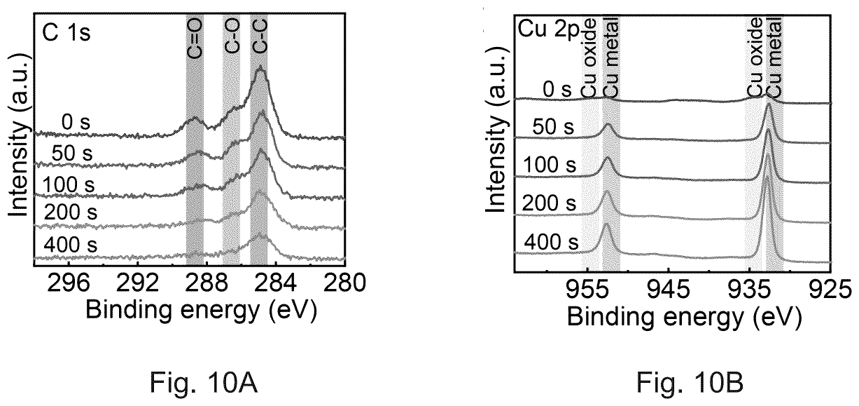

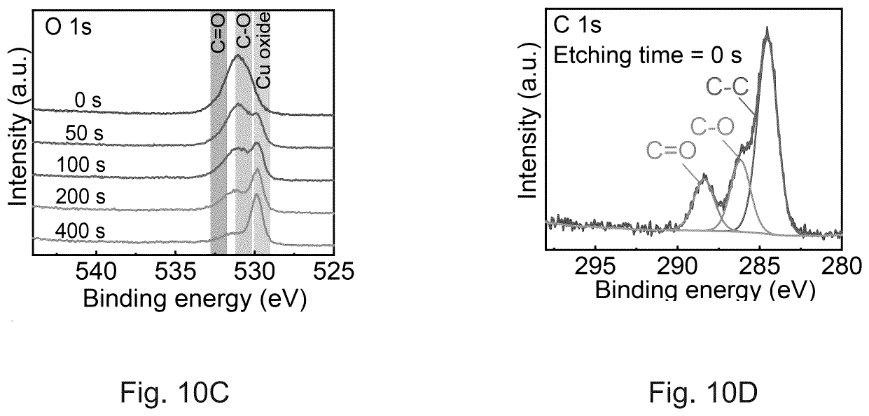

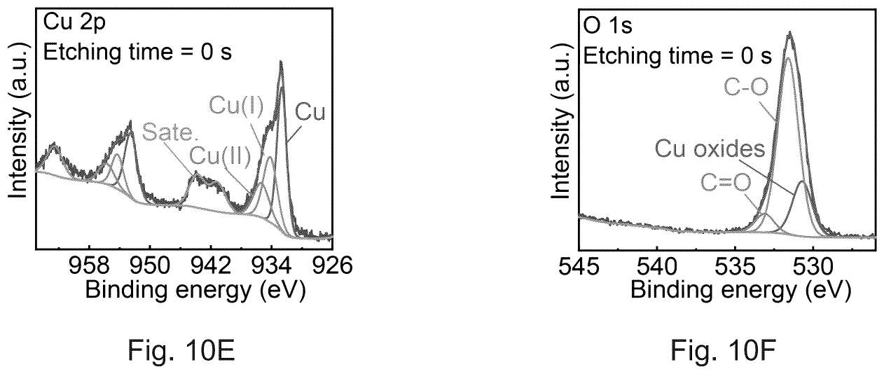

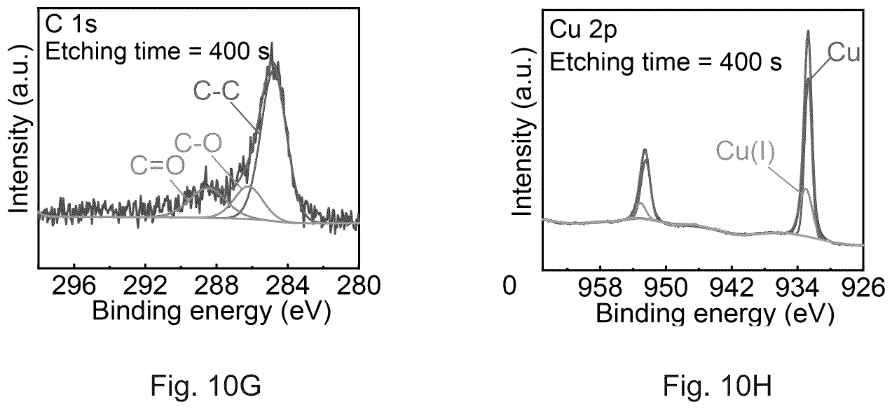

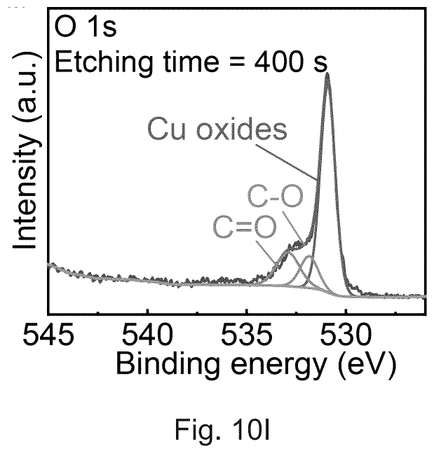

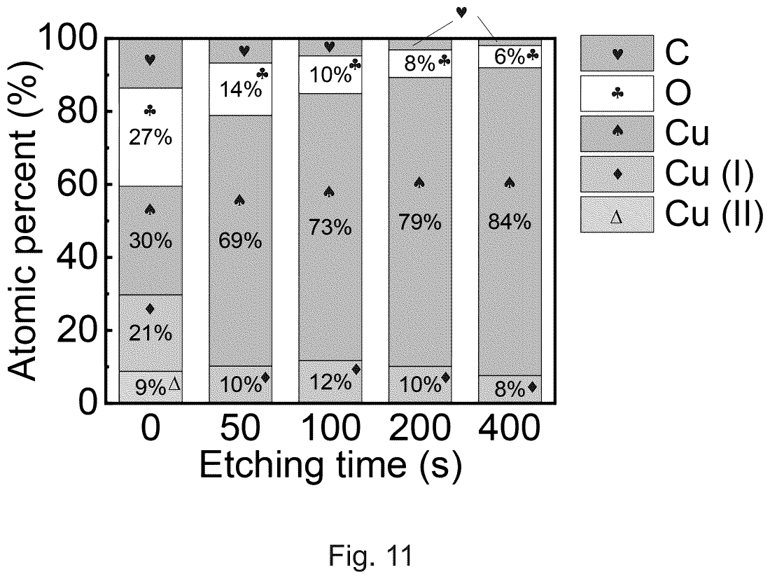

Transmission electron microscopy (TEM) images of a 48 nm-thick Cu NM are presented in FIG. 7 and FIGS. 8A to 8G, demonstrating their nanocrystalline structure with an average grain size of 16 nm, along with various atomic-scale defects such as twinning and stacking faults. In addition to Cu, scanning TEM energy-dispersive X-ray spectroscopy (STEM-EDS) mapping (FIG. 9) confirmed the presence of C and O within these NMs. Selective area electron diffraction (SAED) patterns (FIG. 8C) and X-ray photoelectron spectroscopy (XPS) spectra for Cu, C and O obtained at different etching times (FIGS. 10A to 10I and FIG. 11) indicated that the Cu NMs mainly consisted of nanocrystalline Cu (90% in atomic percentage, 80% in volume fraction) and Cu (I) oxides (approximately 10% in atomic percentage, 20% in volume fraction), with a negligible fraction of C.

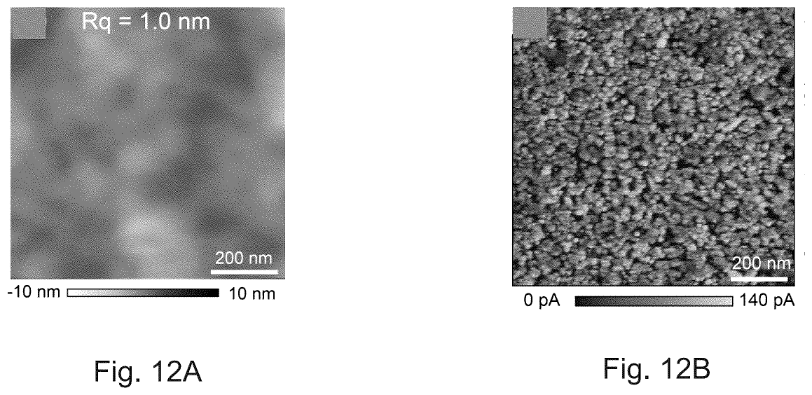

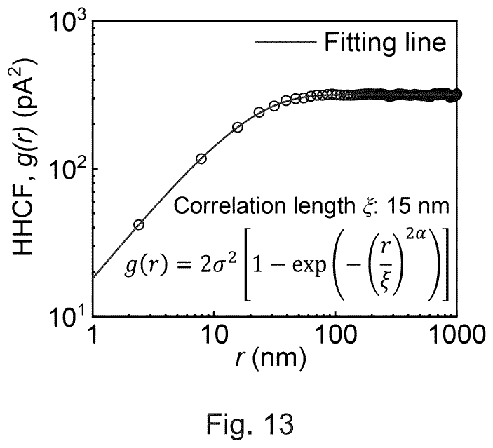

Atomic force microscopy (AFM) scans were conducted on the Cu NMs (FIGS. 12A and 12B). Conductive AFM (C-AFM) images revealed a heterogeneous distribution of local electric conductivity, with less conductive nano-domains dispersed among highly conductive ones within the Cu NMs. The characteristic length of the heterogenous structure, determined from the height-height correlation function (FIG. 12B), was approximately 15 nm (FIG. 13), consistent with the average nanograin size measured from TEM images.

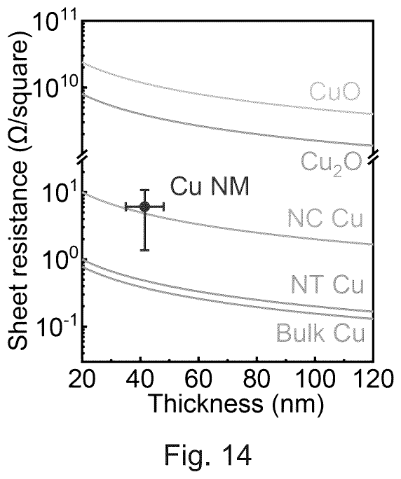

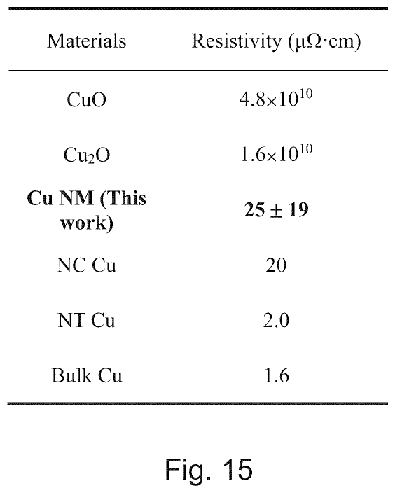

The distribution of electric conductivity demonstrates that the Cu nano-oxides are dispersed throughout the Cu NMs. The sheet resistance of the Cu NMs (FIG. 14) was also measured using the four-point probe (FPP) method and compared it with that of nanotwinned (NT), nanocrystalline (NC) and bulk Cu, CuO, and Cu₂O. Notably, the electrical resistivity extracted for the Cu NMs was approximately 25 μΩ·cm, similar to that of NC Cu (FIG. 15). These findings suggest that the dispersed Cu nano-oxides have minimum impact on the overall electrical conductivity of the Cu NMs.

### Example 3

### Mechanical and Thermal Properties of Cu NMs

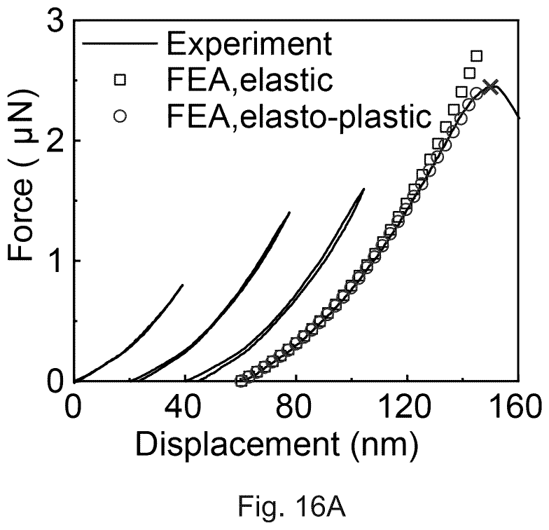

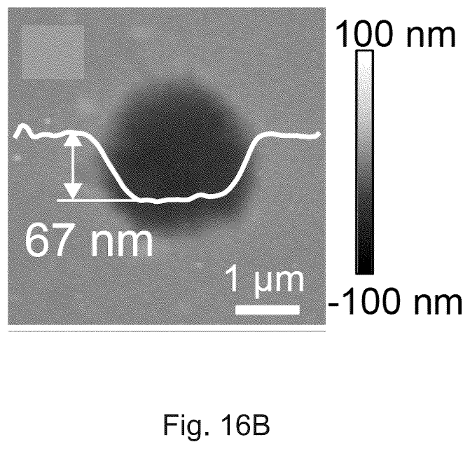

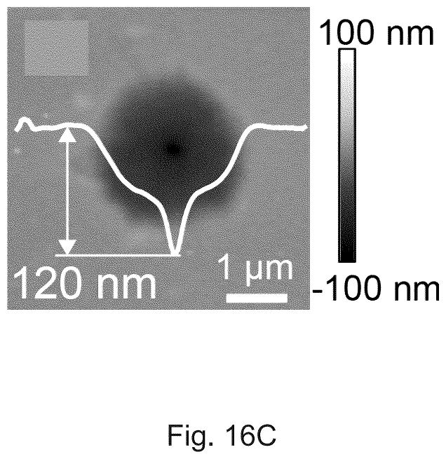

To evaluate the mechanical properties of the Cu NMs, AFM indentation tests were performed on freestanding Cu NMs suspended over circular holes, following the circular drum indentation technique. FIG. 16A illustrates the typical force-displacement curves obtained from a 48 nm-thick Cu NM, while FIGS. 16B and 16C present AFM scanning images of the suspended Cu NM before and after indentation, revealing a ductile fracture mode similar to that observed in Au NMs.

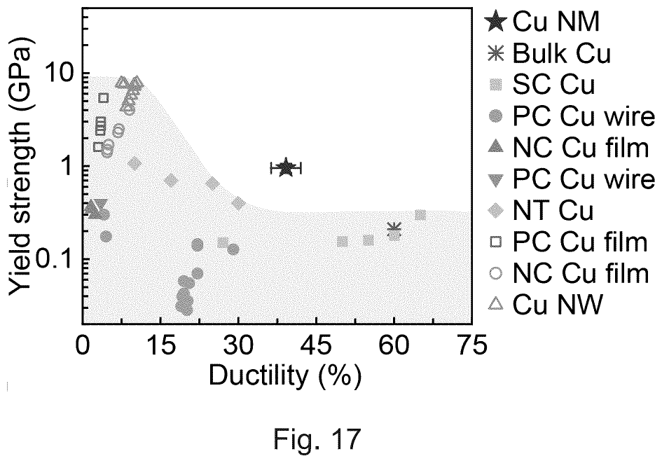

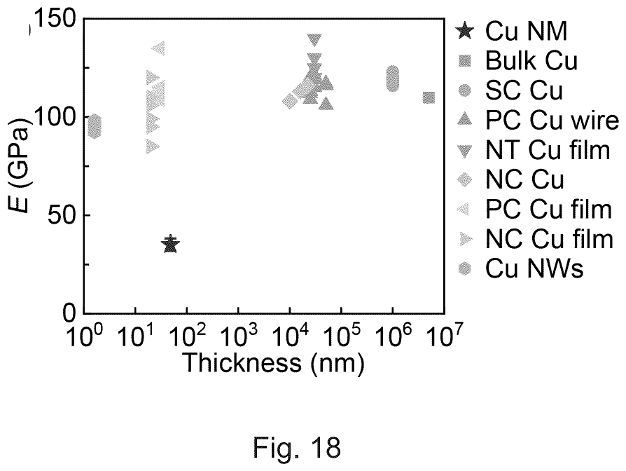

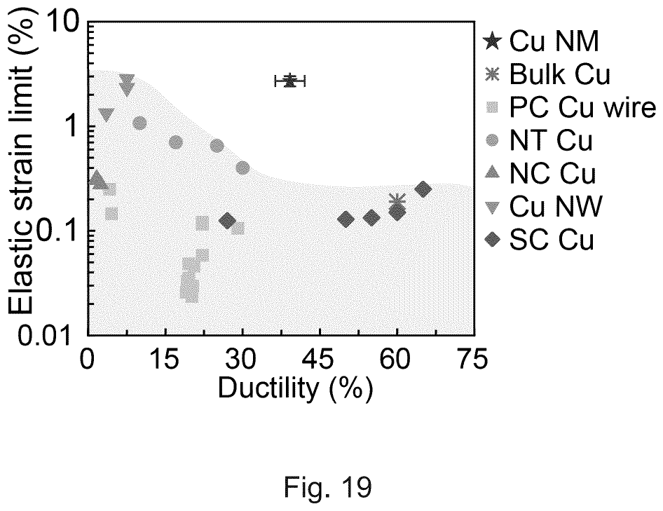

By fitting the experimental data to our finite element analysis (FEA), it is determined that these Cu NMs exhibited a yield strength of 950±100 MPa and a ductility of 40±3% (FIG. 17), surpassing various previously reported forms of Cu, including polycrystalline (PC) Cu, single crystalline (SC) Cu, NC Cu, NT Cu, bulk Cu, and Cu nanowires (NWs). Notably, the strong and ductile Cu NMs displayed a relatively low elastic modulus of E=35±3 GPa (FIG. 18), approximately one third of the bulk Cu, resulting in a superior elastic strain limit of 2.7±0.3% (FIG. 19).

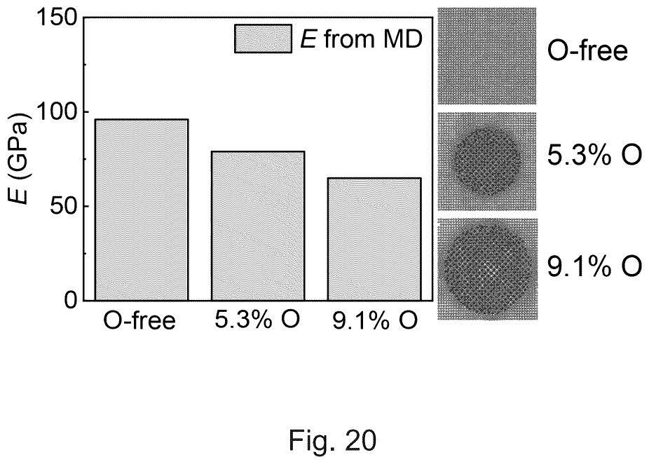

Molecular dynamics (MD) simulations, which will be further discussed in the later part of the present disclosure, revealed that even a small atomic fraction of Cu₂O nano-oxides (e.g., an atomic ratio of 5%-9% for O corresponding to a volume fraction of 20%-40% for Cu₂O) can significantly diminish the elastic modulus of Cu (FIG. 20). Furthermore, numerous defects such as twin boundaries and stacking faults were observed in the NMs of this work (FIGS. 17 and 18 and FIGS. 20 and 21), further diminishing their elastic modulus.

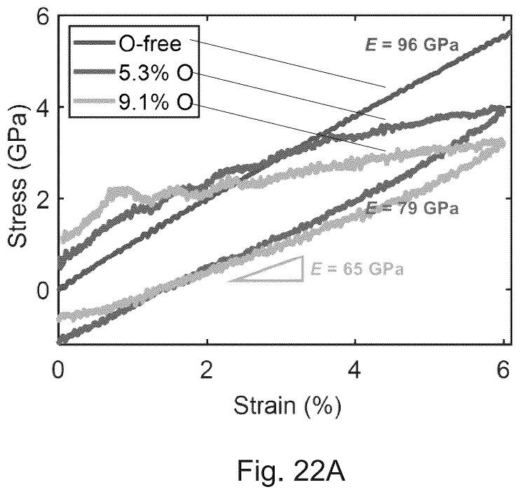

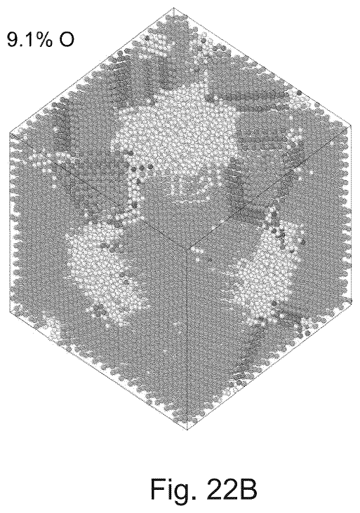

Considering the collective effects of Cu₂O and lattice defects, the MD simulations indicate that the elastic modulus extracted from unloading curves decreases with increasing O concentration, which could reach approximately 60 GPa (FIGS. 22A and 22B). This trend aligns with our experimental observations, suggesting that the decreased modulus of Cu NMs is a result of Cu₂O presence and abundant crystalline defects within them.

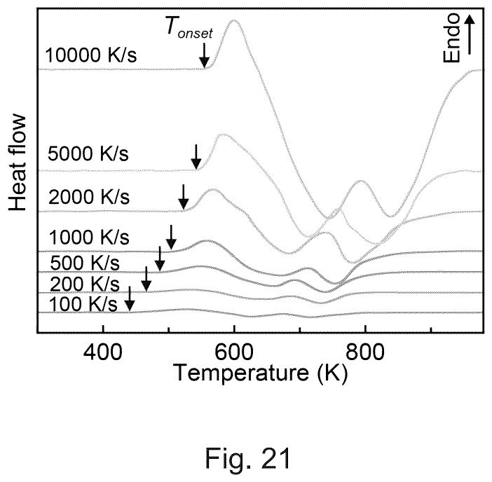

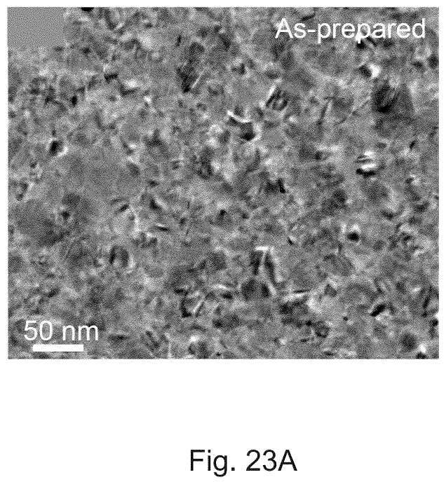

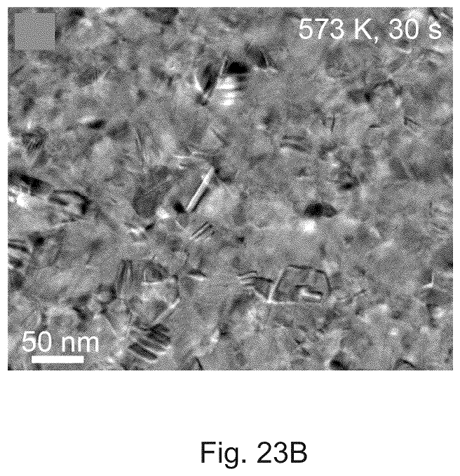

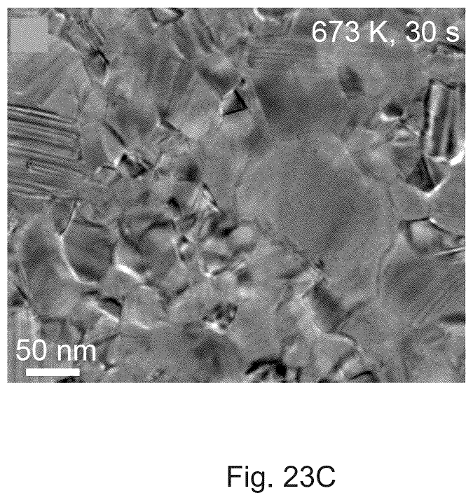

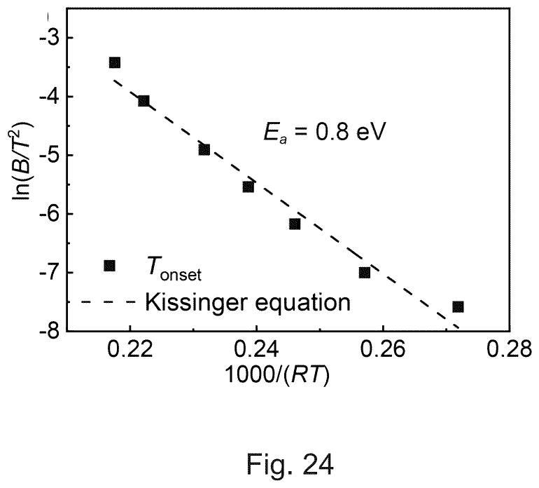

The thermal stability of the Cu NMs was examined via flash differential scanning calorimetry (FDSC). The FDSC curves of the Cu NMs, obtained with heating rates ranging from 10000 K/s to 100 K/s, revealed distinct exothermic peaks occurring between 600 K and 750 K (FIG. 21). To gain insight into the underlying physical mechanisms driving these exothermic reactions, isothermal annealing of the Cu NMs was conducted for 30 seconds at 573 K and 673 K. Upon TEM examination, significant grain growth in the Cu NMs was observed (FIGS. 23A to 23C), indicating that the exothermic peaks can be attributed to grain growth. By fitting the onset temperature of the exothermic reactions to the Kissinger equation, we determined an activation energy (Eu) of 0.8 eV (FIG. 24), which closely matches the activation energy associated with grain growth in bulk NC Cu.

### Example 4

### Cu—Cu Bonding with Cu NMs

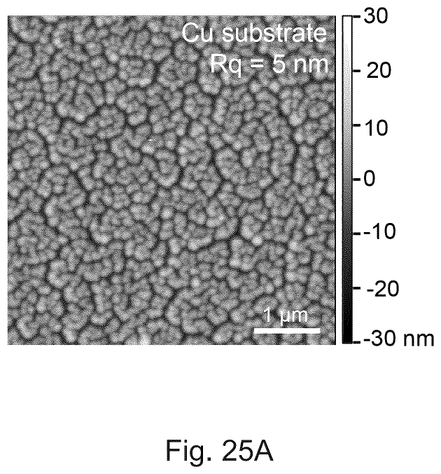

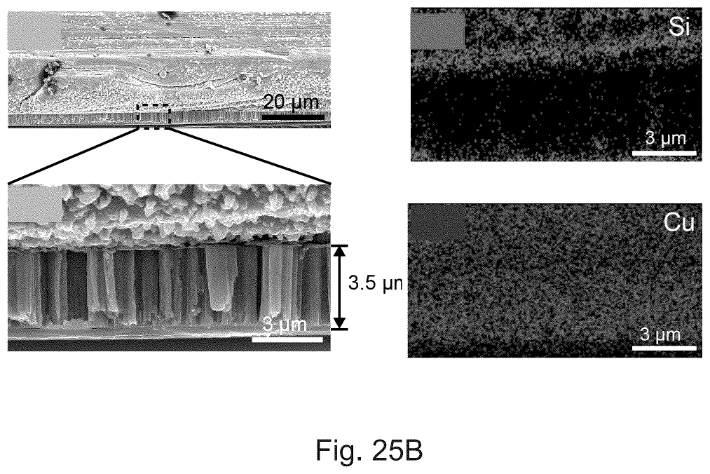

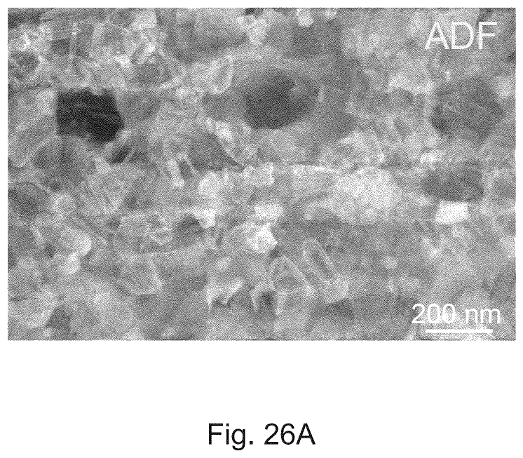

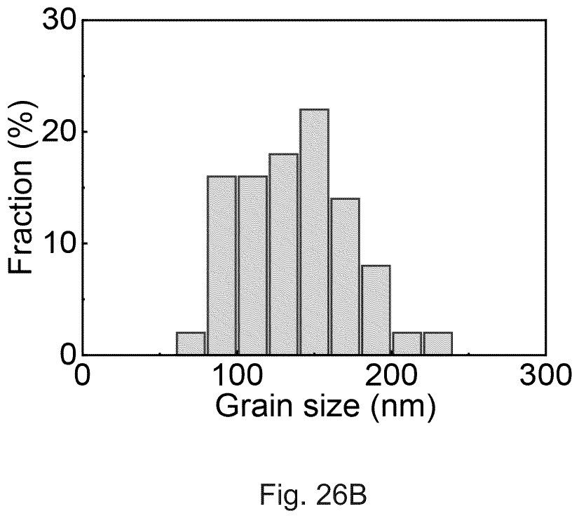

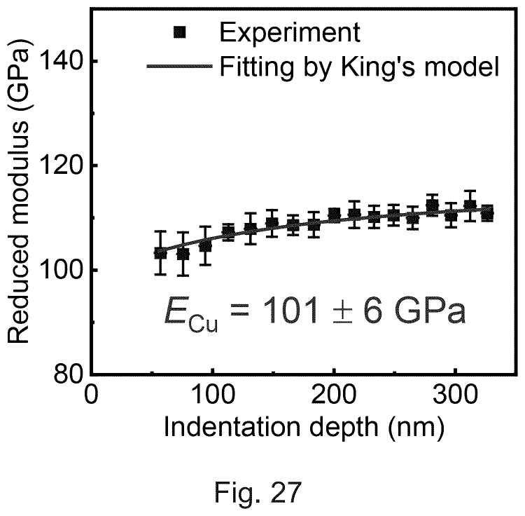

To initiate the Cu—Cu bonding process, a layer of Cu was deposited onto a Si wafer using magnetron sputtering. The deposited Cu could either be patterned using a shadow mask or left unpatterned as the bonding substrates (FIGS. 1A to 1D). The deposited Cu had a thickness of 3.5 mm, with a surface roughness of ˜5 nm (FIGS. 25A and 25B) and an average grain size of approximately 136 nm (FIGS. 26A and 26B). The elastic modulus of the ultrafine-grained Cu was determined to be ˜101 GPa through nanoindentation, where the measured reduced modulus was fitted to the King's model (FIG. 27).

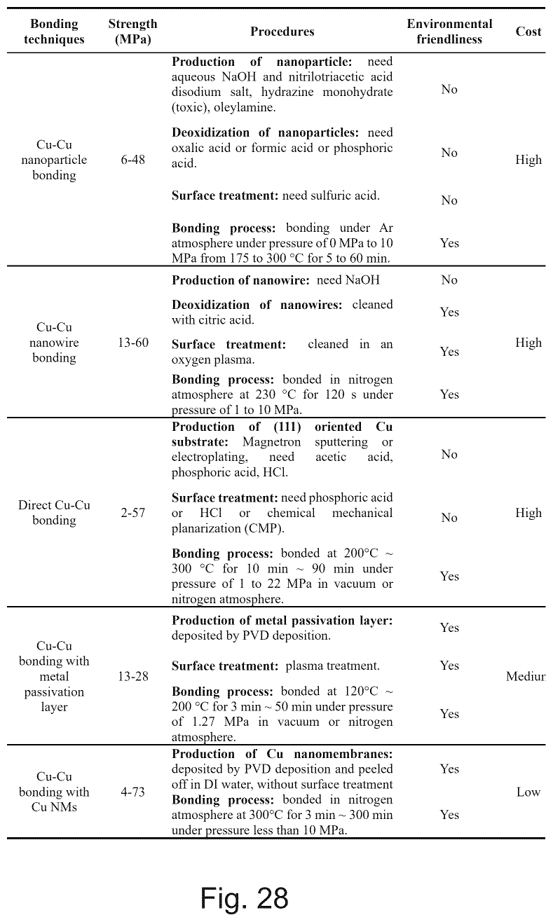

Subsequently, direct Cu—Cu bonding experiments were conducted without the application of Cu NMs. Without wishing to be bound by theory, it is believed that that bonding approach of this work differed from the reported methods which typically involved various surface treatments such as plasma and chemical mechanical planarization (CMP) of Cu surfaces prior to bonding (FIG. 28). Specifically, direct Cu—Cu bonding experiments were carried out without any surface treatment at different temperatures (e.g., 100° C., 200° C. and 300° C.) and for varying time periods (e.g., 3 min, 30 min and 300 min). To ensure contact between the Cu surfaces, a minimum force of 100 N was applied throughout the bonding experiments using a bonding machine (ETOOL, ET-1212-300) (FIGS. 2 and 4).

As shown in FIG. 3, Cu—Cu bonding occurred when the temperature reached 200° C. with a bonding time of 300 minutes, or when the temperature reached 300° C. regardless of the bonding time. Subsequently, a selected number of Cu NMs were transferred onto the Cu surface. Due to their ultrathin thickness, the Cu NMs conformed closely to the Cu surface upon contact. For comparison with the direct Cu—Cu bonding results, NM bonding was performed at the temperature of 300° C. for varying time (3 min, 30 min and 300 min) to facilitate the analysis.

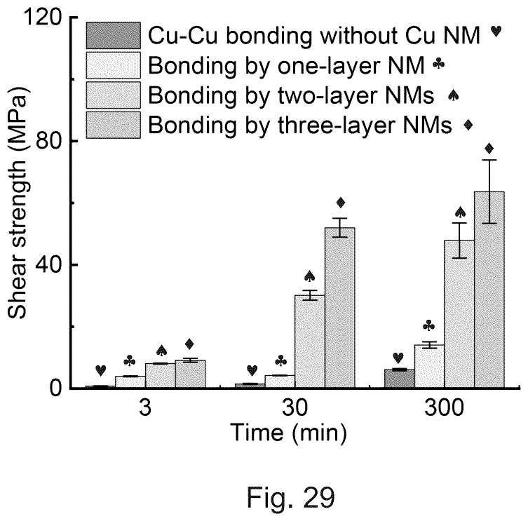

The Nordson Dage 4000 Bond Tester was utilized to measure the average shear strengths of the bonded Cu—Cu surfaces, both with and without Cu NMs. To prevent potential brittle fracture in Si due to excessively strong Cu—Cu, patterned Cu was employed as the bonding medium. FIG. 29 illustrates the measured shear strengths for Cu—Cu bonding with and without Cu NMs. Evidently, with an increased number of transferred Cu NMs onto the Cu substrate, a notable improvement in bonding strength was observed, notably pronounced at bonding durations of 30 or 300 minutes. For instance, at a bonding time of 30 minutes, the average bonding strength was about 1.5 MPa for direct Cu—Cu bonding. However, this value increased to 4 MPa with the addition of one layer of Cu NM and further rose to 52 MPa with three layers of Cu NMs, representing a remarkable 3500% increase (35 times increase). By extending the bonding time to 300 minutes with three layers of Cu NMs, the bonding strength could be further enhanced to 73 MPa. Notably, this value exceeded the reported Cu—Cu bonding strengths achieved under similar temperature and time conditions using various bonding techniques (FIG. 28).

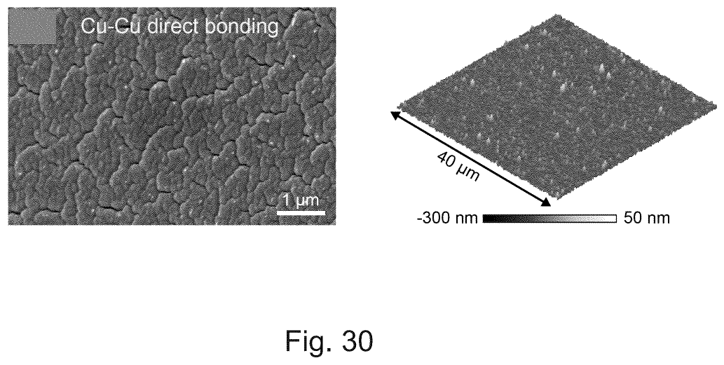

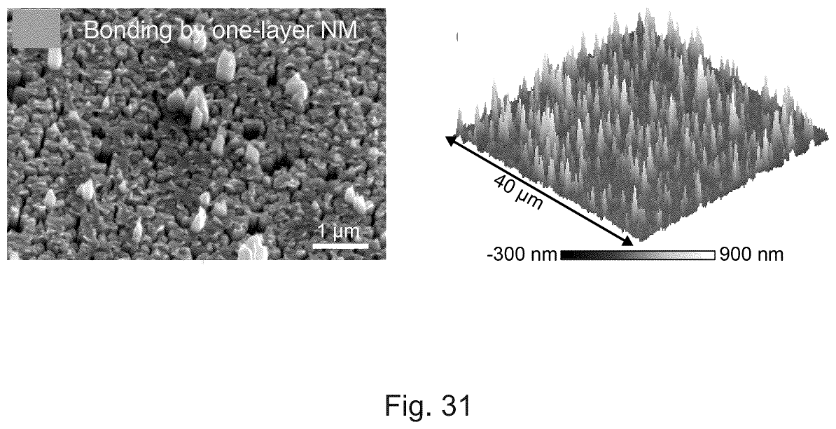

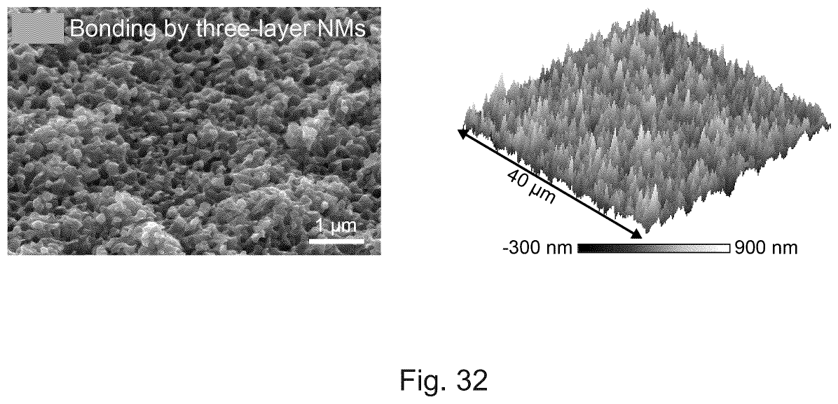

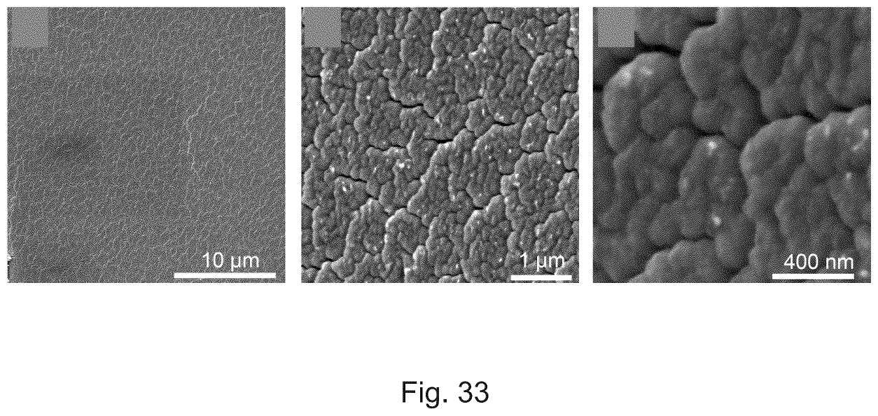

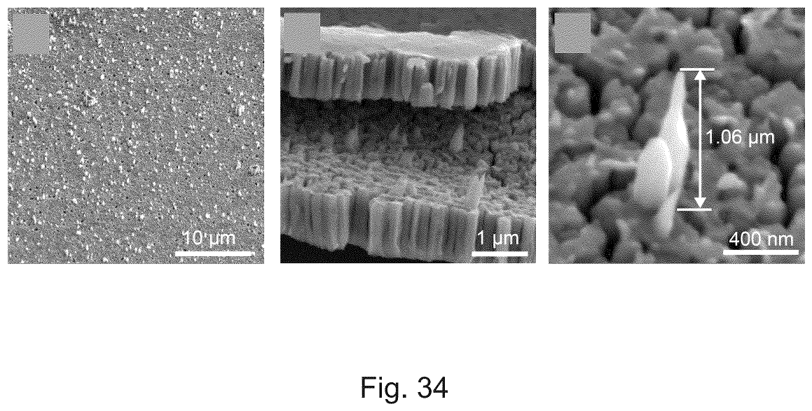

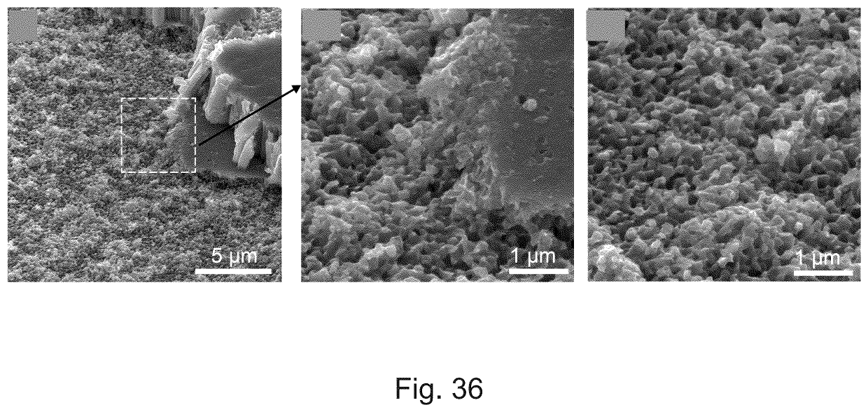

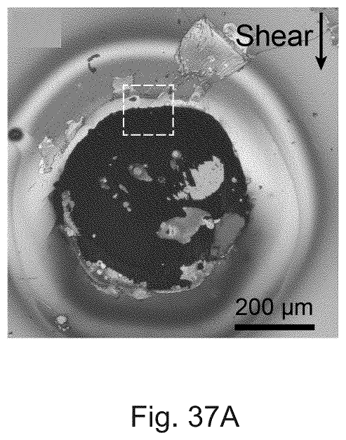

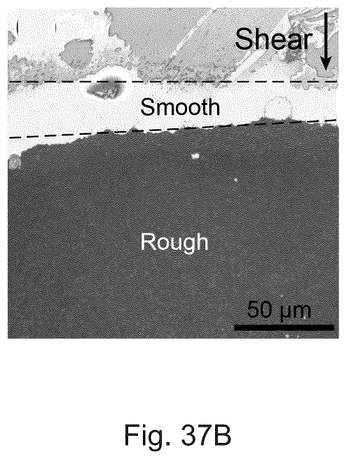

Subsequently, an analysis of the fractured surfaces following the debonding process between the bonded Cu—Cu surfaces was conducted. Notably, a transition in the morphology of interfacial fracture from brittle to tough was observed as the number of transferred Cu NMs increased, as depicted in FIGS. 30 to 32 and FIGS. 33 to 36. In the case of direct Cu—Cu bonding without Cu NMs (FIGS. 30 and 33), the fracture surface exhibited a cleavage-like morphology, consistent with weak interface bonding and brittle fracture. In contrast, Cu—Cu bonding with one layer of Cu NM displayed numerous protrusions on the fracture surface (FIGS. 31 and 34). Moreover, Cu—Cu bonding with three layers of Cu NMs resulted in a rugged morphology with significant protrusions and dimples (FIGS. 32 and FIGS. 35 and 36). According to the optical microscopy results, as shown in FIGS. 37A and 37B, a distinct smooth fracture zone was observed at the periphery of the typical fracture regions characterized by dimples. It is believed that such smooth fracture zones typically indicate the initiation of fractures, hence implying that the initial cracking likely originated from the interface between the Cu and the Cu NM. These rugged fracture surface morphologies indicate the presence of a tortuous cracking path along the bonded Cu—Cu surfaces, a characteristic typically associated with tough interfacial fracture.

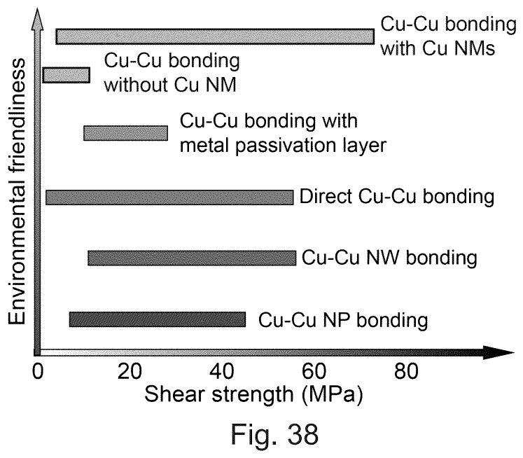

In addition to bonding strength, it is essential to consider the cost and the environmental friendliness when developing Cu—Cu bonding techniques. These factors are closely related to the use of potentially harmful chemicals in the bonding process. In this study, the environmental impact and cost associated were assessed with various bonding techniques by examining the chemicals employed, such as NaOH, HCL, H₂SO₄, and toxic hydrazine monohydrate (see FIG. 28 for details). The Cu NM bonding method of this work stands out in terms of cost, environmental friendliness, and ultra-high bonding strength (FIG. 38). This is primarily due to the exclusive use of deionized (DI) water for producing Cu NMs, which significantly reduces the fabrication cost of nanomaterials. Furthermore, the bonding method of this work eliminates the need for surface treatments, further enhancing its cost-effectiveness and environmental sustainability. Therefore, it is believed that the Cu NM bonding technique of this work offers a compelling advantage over other bonding techniques in terms of its low cost, environmental friendliness, and ability to achieve exceptionally high bonding strength (FIG. 38).

### Example 5

### Toughening Mechanisms in NM Bonding

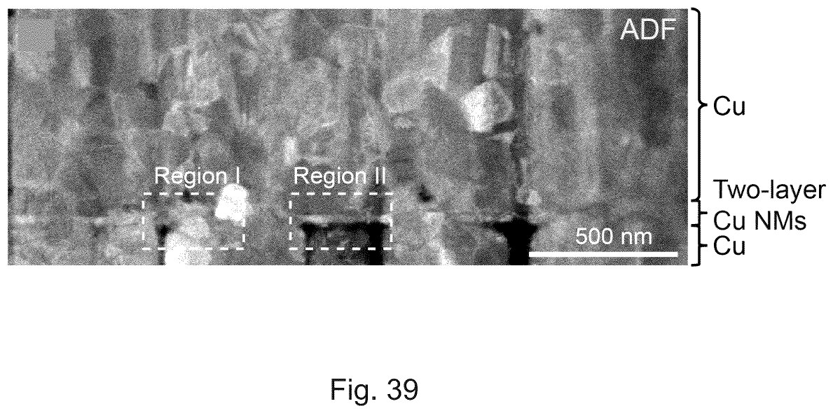

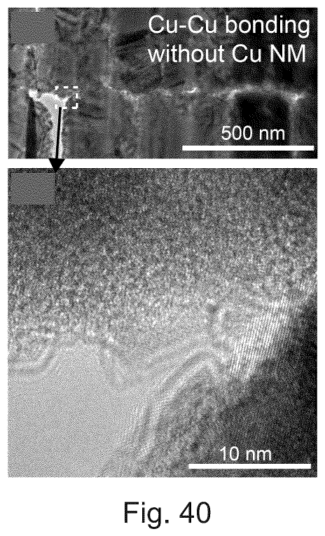

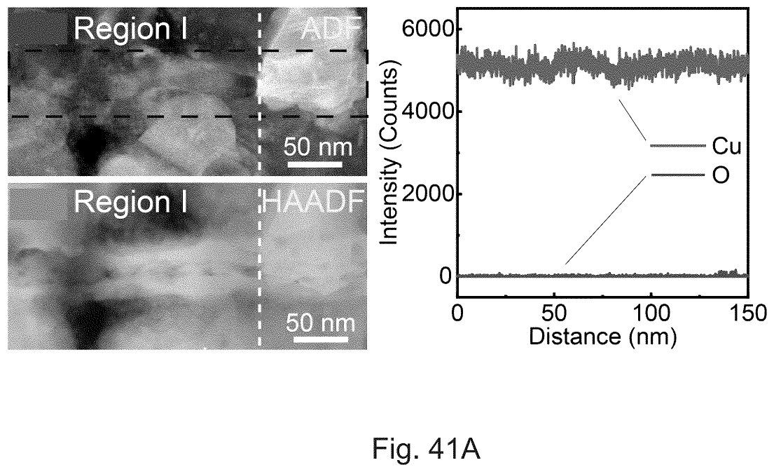

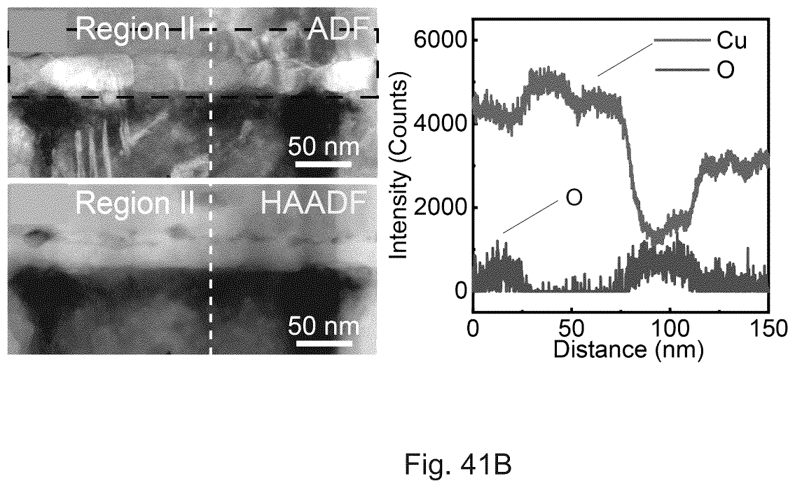

To gain insights into the toughening mechanisms of Cu—Cu bonding with Cu NMs, the focused-ion beam technique was employed to perform a cross-sectional cut of a bonded sample and TEM analysis of the bonding interface was conducted. TEM images in FIG. 39 depict the bonded Cu—Cu interface with two layers of Cu NMs. Notably, the presence of Cu NMs effectively sealed “voids” or “nano-sized gaps” that are typically observed in direct Cu—Cu bonding (FIG. 40). Additionally, significant growth of nanocrystals across the bonded interface in regions without Cu oxides was observed (e.g., Region I in FIG. 39). This growth of Cu nanocrystals spanning the two-layer Cu NMs is supported by the HAADF-STEM images and EDS analysis (FIG. 41A).

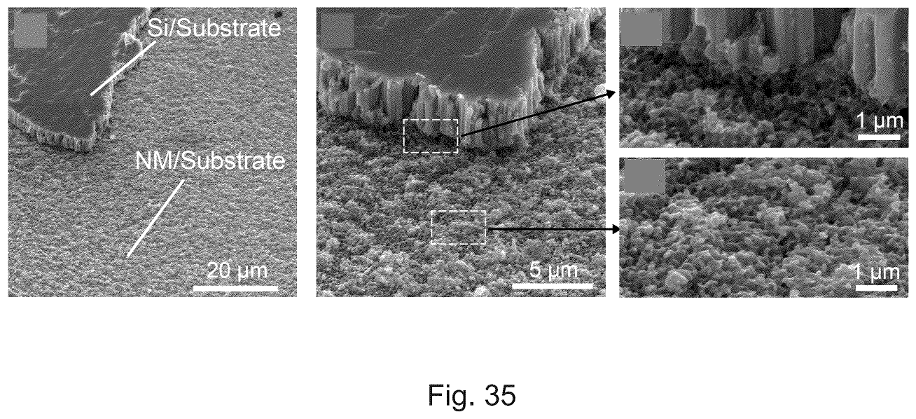

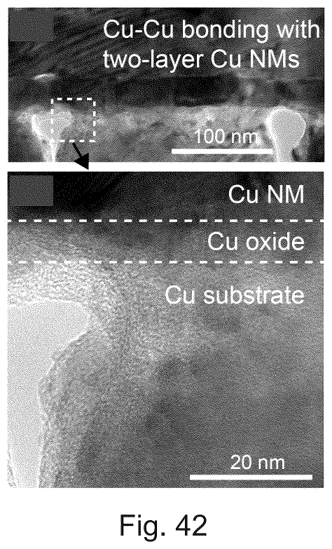

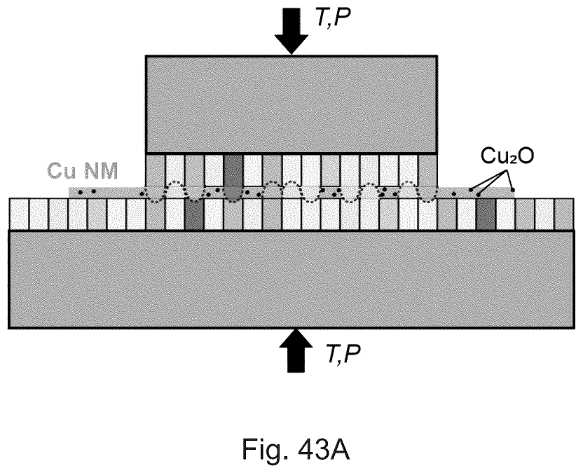

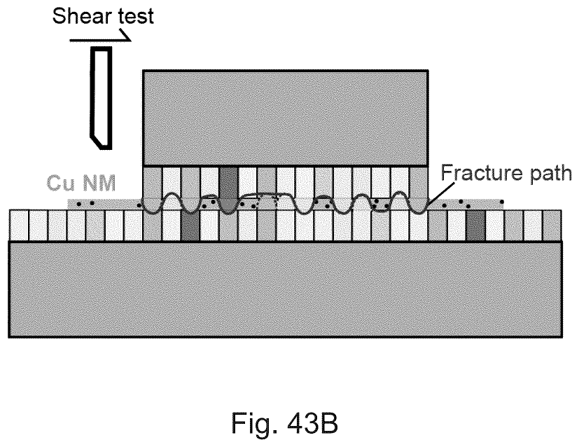

In contrast, regions containing substantial amounts of Cu oxides (region II in FIG. 39) impeded the growth of Cu nanocrystals most likely due to the presence of Cu oxides (FIG. 41B). Remarkably, within these oxide-rich regions, it is observed that cracking occurring within the Cu crystals in the neighborhood of Cu NMs, accompanied by crack-tip blunting, signifying ductile fracture at the nano-scale (FIG. 42). Conversely, in cases of direct Cu—Cu bonding, cracking resulted in a sharp crack tip at the atomic scale, and fracture took place along the interface (FIG. 40, bottom). These TEM results provide a compelling evidence of cleavage-type interfacial fracture in direct Cu—Cu bonding, while Cu—Cu bonding with Cu NMs exhibits ductile fracture. It is thus believed that the toughening mechanism inherent in Cu NM bonding is linked to a tortuous cracking pathway, as illustrated in FIGS. 35 and 36 and FIGS. 43A and 43B. This pathway is a consequence of interface heterogeneities arising from the substantial growth of Cu nanocrystals in regions devoid of nano-oxides and the tough interfacial bonding in areas abundant with nano-oxides. These observations align with the fracture surface morphologies presented in FIGS. 30 to 32.

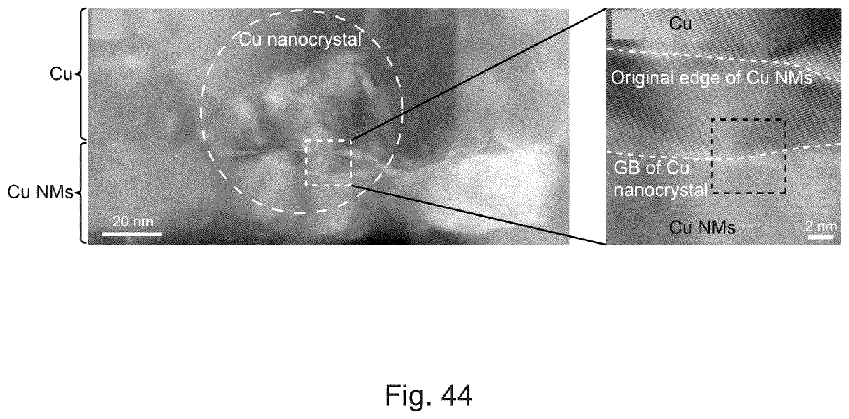

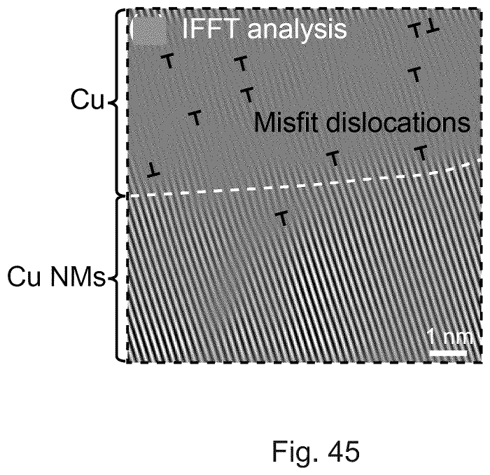

In order to gain a deeper understanding of how Cu grain growth is facilitated by Cu NMs, an examination of the leading edge of a Cu nanograin that originated from the Cu substrate and extended into the Cu NM was conducted, as depicted in FIG. 44, left. The lattice misorientation at the grain growth front is highlighted in FIG. 44, right. By applying inverse Fast Fourier Transformation (IFFT) analysis to the HRTEM image (FIG. 45), a significant presence of misfit dislocations in the region of the Cu substrate was observed, whereas the Cu NMs displayed only a few dislocations.

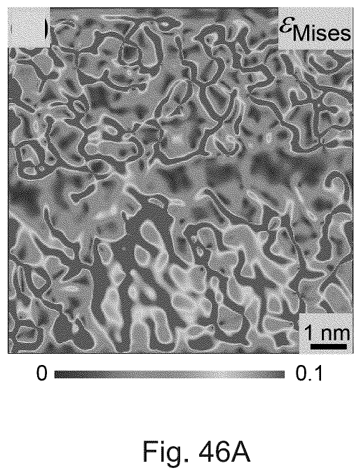

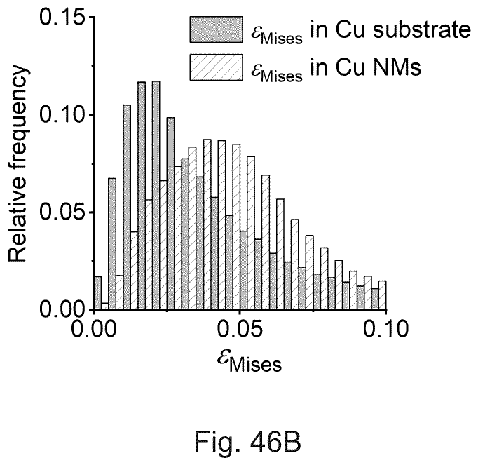

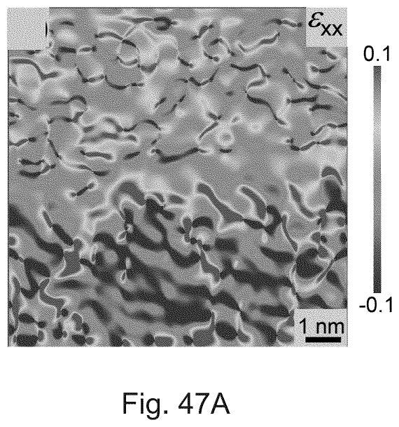

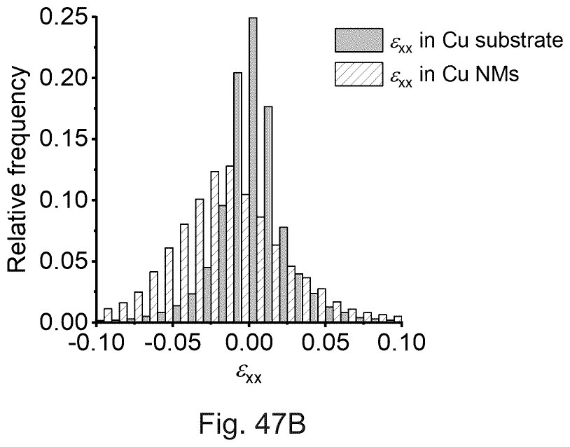

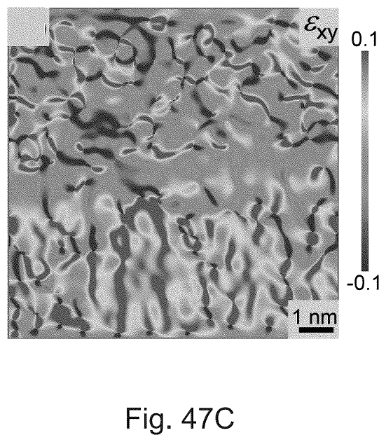

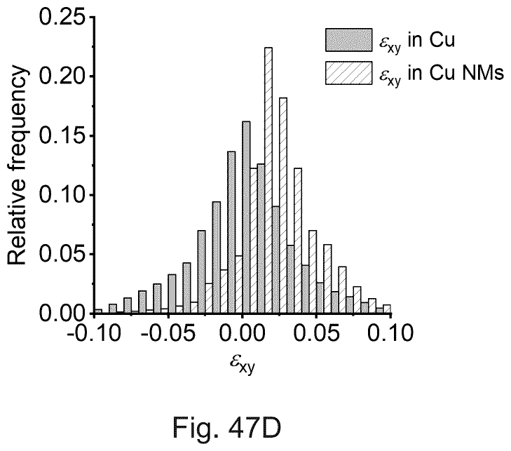

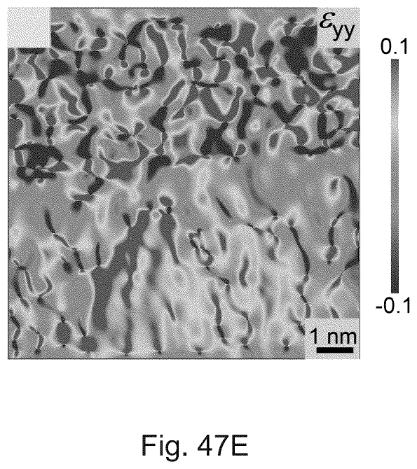

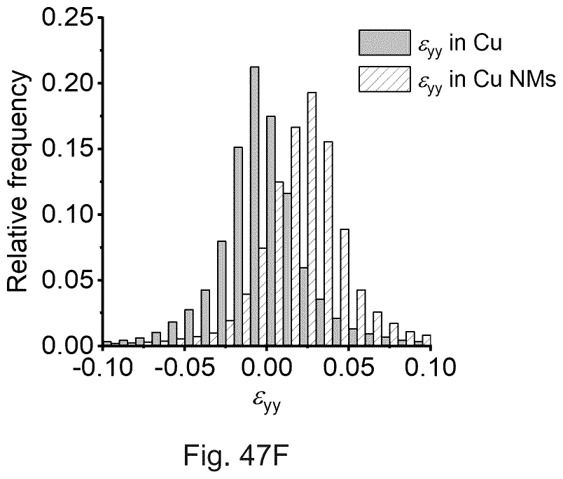

The lattice strain was calculated using geometric phase analysis (GPA) (FIGS. 46A and 46B and FIGS. 47A to 47F). Notably, there was a relatively large von Mises strain field in the Cu NMs compared to the Cu substrate, despite the former having fewer defects. This behavior indicates that the Cu NMs undergo elastic shearing during grain growth. Essentially, this elastic shearing within the Cu NMs can be explained by the elastic mismatch between the Cu NM (with E=35 GPa) and the Cu substrate (with E=101 GPa) when they are pressed together. It is believed that said elastic shearing may be a phenomenon similar to the promoted grain growth in NC Cu induced by cold rolling when stress is applied to the NC Cu. Moreover, experiments revealed a low activation energy for grain growth within Cu NMs (FIG. 24). Consequently, once Cu nanocrystals crossed the bonding interface and entered the elastically stressed Cu NMs, they could easily propagate throughout the entire Cu NMs, as observed in FIG. 39.

### Example 6

### Atomistic Mechanisms of NM Bonding

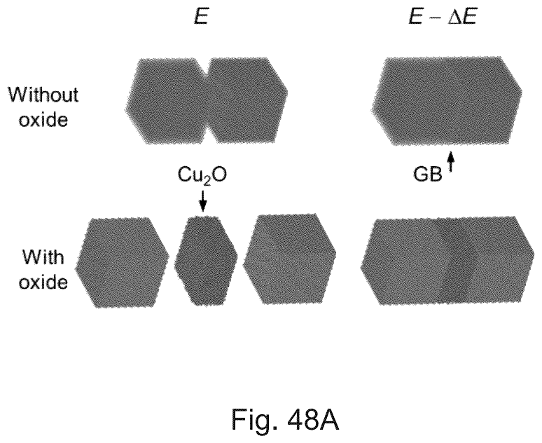

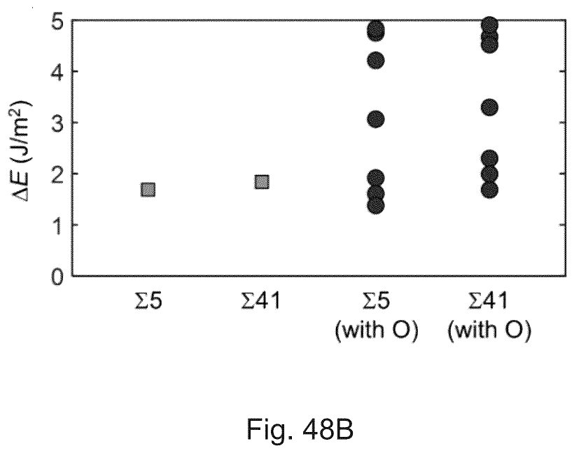

To further understand the bonding mechanisms, MD simulations were conducted using bi-crystal copper models with coincidence-site-lattice tilt GBs. Additionally, scenarios involving a Cu₂O interlayer based on the experimental observations of dispersed Cu₂O within the Cu NMs were investigated. Structural relaxation was performed both before and after bonding, as depicted in FIG. 48A. The thermodynamic driving force for bonding ΔE (i.e., the decrease of energy after bonding) in the bi-crystal Cu and Cu₂O∥Cu models with different misorientations were calculated (FIG. 48B).

For the bi-crystal Cu, it is observed that ΔE=1.9 J/m² in the Σ41[001](910) model with a misorientation angle of 12.68°, which was higher than ΔE=1.7 J/m² in the Σ5[001](210) with a misorientation angle of 53.13°. It is believed that this result aligns with the commonly adopted strategy of metal-metal bonding, which involves minimizing misorientation to facilitate easier bonding. However, it is also found that the driving forces for the Cu₂O∥Cu interface with oxide layers could be further increased to 1.5-5 J/m². It is worth noting that the different data points correspond to Cu₂O samples with randomly assigned orientations, resulting in misfit angles ranging from 14° to 57° between (100)_{Cu} and (100)_{Cu2O} faces.

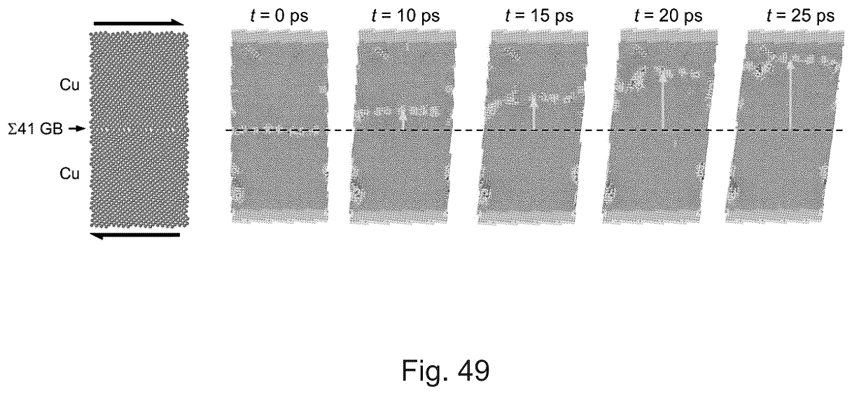

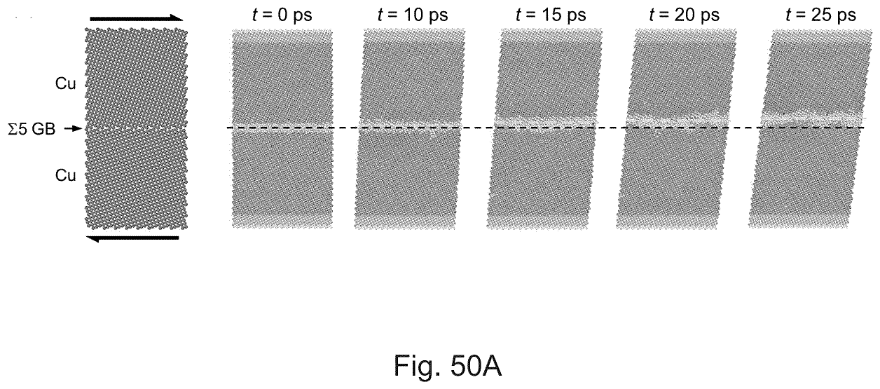

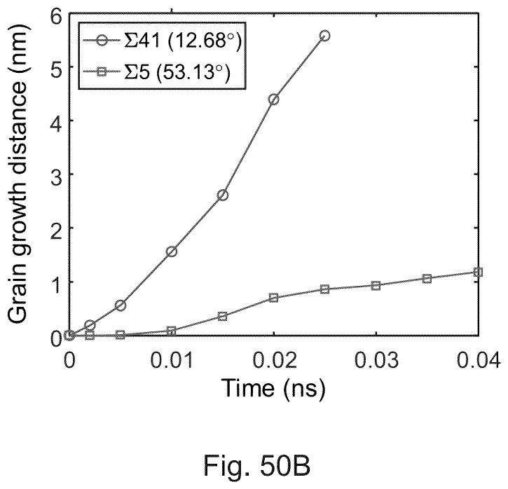

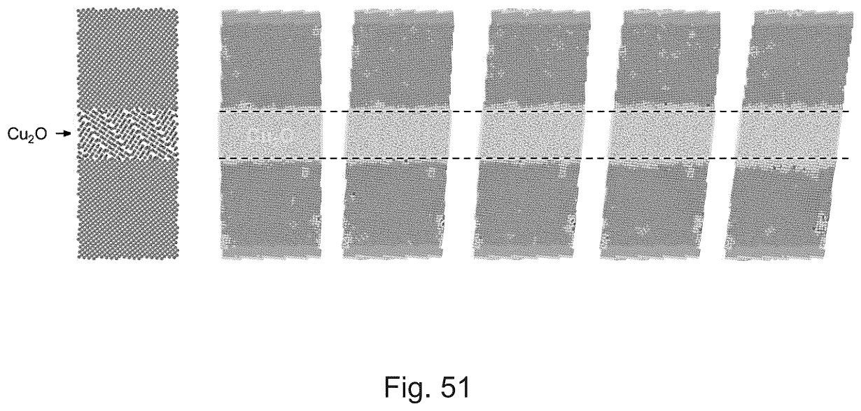

In addition to thermodynamic considerations, the temporal evolution of the bonded interfaces was examined. The GB migration kinetics responsible for grain growth across the interface under shear strain was analyzed, as evidenced in the NMs through strain mapping (FIG. 46A and FIGS. 47C and 47D). The simulation results indicated that the GB mobility is dependent on the misorientation angle, with the GB migrating much faster in the Σ41[001](910)) model (FIG. 49) compared to the Σ5[001](210) model with a misorientation angle of 53.13° (FIGS. 50A and 50B). Conversely, the presence of an oxide interlayer completely suppressed interface kinetics (FIG. 51). Although Cu oxides impede the growth of Cu nanocrystals, it is believed that they also play a positive effect on Cu NM bonding due to their strong driving force to bond with Cu nanocrystals. Importantly, the MD simulation results indicate significant grain growth in the Cu NM under shear strain, consistent with the enhanced GB migration observed in FIGS. 44 and 45 and FIGS. 46A and 46B.

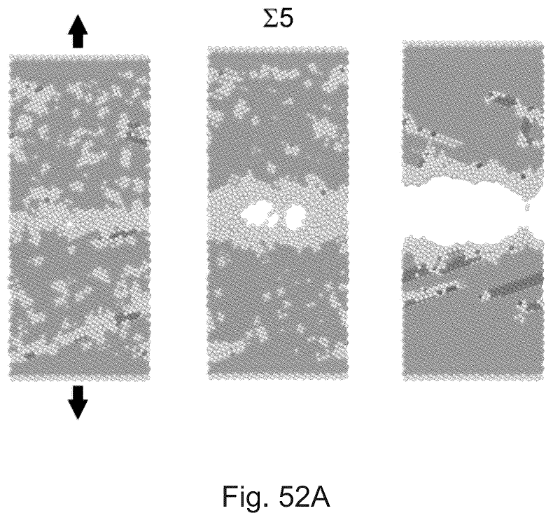

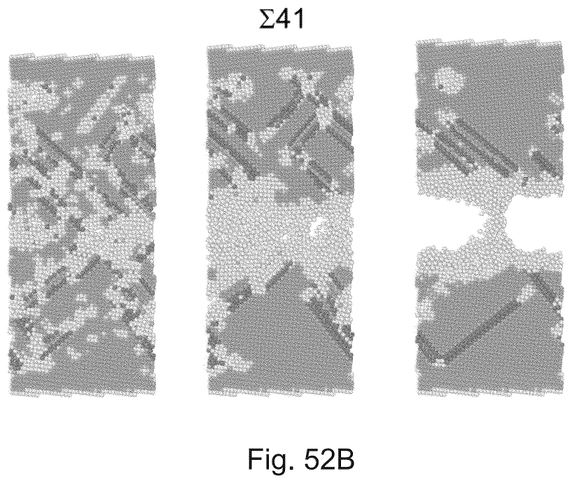

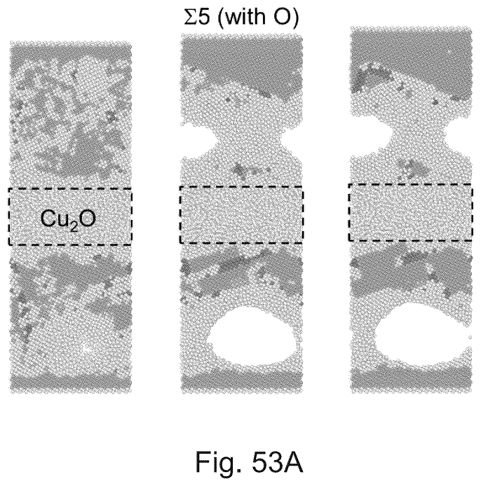

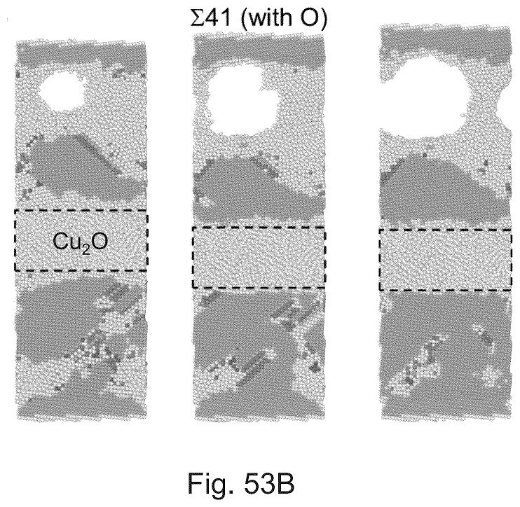

Subsequently, the interfacial fracture processes of the bonded models were investigated. Uniaxial tension was applied to the atomistic models with the loading direction perpendicular to the interface. In the bi-crystal models without oxide, damage initiation at the GBs was observed, followed by the development of fully formed interfacial cracks (FIGS. 52A and 52B), which is consistent with fracture path observed in Cu—Cu direct bonding (FIG. 40). These fracture processes were accompanied by the generation of stacking faults to dissipate the elastic energy. In contrast, interfaces in models with a Cu₂O interlayer did not exhibit crack formation. Instead, void nucleation and growth occurred inside the copper nanograins at high strains, demonstrating a ductile fracture behavior (FIGS. 53A and 53B), which is in line with the experimental findings (FIG. 42). This indicates that, in addition to growing Cu crystals, the presence of the nano-dispersed oxide is also beneficial for the formation of a strong and ductile bonding interface in Cu NM bonding.

The invention has been given by way of example only, and various other modifications of and/or alterations to the described embodiment may be made by persons skilled in the art without departing from the scope of the invention as specified in the appended claims.

1. A composite material for bonding copper to copper comprising a copper-based heterogeneous nanostructure, wherein the copper-based heterogeneous nanostructure comprises a nanocrystalline copper and dispersions of copper oxide.

2. The composite material as claimed in claim 1, wherein the nanocrystalline copper is interspersed with the dispersions of copper oxide.

3. The composite material as claimed in claim 1, wherein the nanocrystalline copper and the dispersions of copper oxide have a volume ratio of about 8:2.

4. The composite material as claimed in claim 1, wherein the nanocrystalline copper and the dispersions of copper oxide have an atomic percentage ratio of about 90%:10%.

5. The composite material as claimed in claim 1, wherein the heterogeneous nanostructure has an average grain size of about 16 nm.

6. The composite material as claimed in claim 1, wherein the heterogeneous nanostructure includes at least one type of material defect of crystallography derived from lattice structures of the nanocrystalline copper and the dispersions of copper oxide.

7. The composite material as claimed in claim 6, wherein the at least one type of material defect of crystallography comprises twin boundary and stacking faults.

8. The composite material as claimed in claim 6, wherein the nanocrystalline copper has a lattice structure of hexagonal close packing symmetry.

9. The composite material as claimed in claim 6, wherein the dispersions of copper oxide are dispersions of copper (I) oxide having a mixed lattice structure of body-centered cubic symmetry and face-centered cubic symmetry.

10. The composite material as claimed in claim 1 is in form of a membrane.

11. The composite material as claimed in claim 10, wherein the membrane has a thickness ranging from about 35 nm to about 50 nm.

12. The composite material as claimed in claim 10, wherein the membrane has a lateral size of ≥1 cm.

13. The composite material as claimed in claim 10 having at least one of the following mechanical characteristics: a yield strength of about 850 MPa to about 1050 MPa; a ductility of about 37% to about 43%; an elastic modulus of about 32 GPa to about 38 GPa; and an elastic strain limit of about 2.4% to about 3.0%.

14. The composite material as claimed in claim 1 is adapted to be disposed between a first and a second copper surfaces for bonding under a condition of a temperature of about 200° C. to about 300° C., a pressure of 10 MPa and in a vacuum of 2×10⁻² Pa, for about 3 min to about 300 min.

15. The composite material as claimed in claim 14, wherein at least one of the first and the second copper surfaces is a patterned copper surface.

16. The composite material as claimed in claim 14 bonds the first and the second copper surfaces with an internal shear strength, wherein the internal shear strength is up to about 73 MPa at room temperature.

17. The composite material as claimed in claim 16, wherein the internal shear strength is about 35 times greater than that of a copper-copper bond without the composite material.

18. A method of preparing the composite material as claimed in claim 1 comprising the steps of:
(a) depositing a layer of Cu onto a water-absorbing substrate by ion beam sputtering or electron beam evaporation;
(b) immersing the deposited water absorbing substrate of (a) into water for absorption for a predetermined of time;
(c) separating the composite material from the deposited water-absorbing substrate.

19. The method as claimed in claim 18, wherein the water-absorbing substrate in step (a) comprises a composite substrate in dehydrated form.

20. The method as claimed in claim 19, wherein the composite substrate in dehydrated form is prepared by the step of spin-coating a layer of hydrogel onto a base substrate, followed by dehydrating the spin-coated layer of hydrogel.

21. The method as claimed in claim 20, wherein the layer of hydrogel comprises poly(vinyl alcohol) (PVA).

22. The method as claimed in claim 20, wherein the base substrate comprises glass or polyimide (PI).

23. The method as claimed in claim 20, wherein the step of spin-coating of the layer of hydrogel comprises spin-coating a PVA solution onto a glass plate to form a PVA-glass composite substrate.

24. The method as claimed in claim 23, wherein the spin-coating is carried out at about 1000 to about 3000 rpm for about 30 to about 300 seconds.

25. The method as claimed in claim 23, wherein the PVA solution has a concentration of about 8 wt. % to about 11 wt. %.

26. The method as claimed in claim 23, wherein the PVA-glass composite substrate is dehydrated at about 60° C. to about 90° C. for about 1 to about 24 hours.

27. The method as claimed in claim 18, wherein the electron beam evaporation is carried out under a pressure of less than 6×10⁻⁴ Pa at a nominal deposition rate of about 1 Å/s.

28. The method as claimed in claim 18, wherein the ion beam sputtering is carried out under a stable deposition rate.

29. The method as claimed in claim 18, wherein the deposited water-absorbing substrate of (a) is immersed into water for about 120 seconds to about 600 seconds.

30. A method of fabricating a joined body comprising the step of:
(a) disposing one or more layer of the composite material as claimed in claim 1 between a first copper surface and a second copper surface, to form a pre-joined body;
(b) annealing the pre-joined body in step (a) for bonding the first and the second copper surfaces through the one or more layer of the composite material;
wherein the first and the second copper surfaces in step (a) are non-planarized surfaces.

31. The method as claimed in claim 30 further comprising the step of applying a pressure of about 10 N to about 100 N to the pre-joined body in step (a) to facilitate contact of the first copper surface, the composite material and the second copper surface.

32. The method as claimed in claim 30, wherein step (b) is carried out under a condition of a temperature of about 200° C. to about 300° C., a pressure of 10 MPa and in a vacuum of 2×10⁻² Pa, for about 3 min to about 300 min.

33. The method as claimed in claim 30, wherein at least one of the first and the second copper surfaces is a layer of copper deposited on a base substrate comprising Si wafer.

34. The method as claimed in claim 33, wherein the layer of copper partially covers the base substrate.

35. The method as claimed in claim 33, wherein the layer of copper fully covers the base substrate.

36. The method as claimed in claim 30, wherein each of the first and the second copper surfaces is a layer of copper deposited on a base substrate comprising Si wafer.

37. The method as claimed in claim 33, wherein the layer of copper is deposited on the based substrate by magnetron sputtering.
